(19) United States
(12) Patent Application Publication
(10) Pub. No.: US 2015/0136690 A1
(43) Pub. Date: May 21, 2015

(54) METHOD OF MAKING A MEMBRANE AND A MEMBRANE FOR WATER FILTRATION

(71) Applicant: National University of Singapore, Singapore (SG)

(72) Inventors: Wenyuan Xie, Singapore (SG); Yen-Wah Tong, Singapore (SG); Honglei Wang, Singapore (SG); Bingfang Wang, Singapore (SG); Fang He, Singapore (SG); Kandiah Jeyaseelan, Singapore (SG); Arunmozhiarasi Armugam, Singapore (SG)

(73) Assignee: National Unibersity of Singapore, Singapore (SG)

(21) Appl. No.: 14/402,845

(22) PCT Filed: May 31, 2013
(86) PCT No.: PCT/SG2013/000227

§ 371 Date: Nov. 21, 2014

(30) Foreign Application Priority Data
Jun. 1, 2012 (SG) 201204108-3

(51) Int. Cl. B01D 69/14; B05D 1/18; C02F 1/44; B01D 67/00; B01D 71/80; B01D 71/16

(52) U.S. Cl. CPC B01D 69/144; B01D 71/80; B01D 71/16; C02F 1/44; B01D 67/0006; B05D 1/18; C02F 2103/08
USPC 210/500.3; 427/244

(57) ABSTRACT

A method of making a membrane and a membrane made from the method are provided. The method comprises coupling a vesicle to a support substrate, the vesicle comprising a plurality of water channels; and partially embedding the vesicle coupled to the support substrate in a layer of material that is substantially impermeable to water to form the membrane.

### TECHNICAL FIELD

The present disclosure relates broadly to a membrane that is suitable for water filtration and a method of making such membranes.

### BACKGROUND

Membrane technology has been used in a number of characteristically different separation processes. Notably, membrane technology is widely used in water purification processes to remove particles and/or solutes with sizes ranging from microns to nanometers. The working principle is based on a membrane acting as a selective filter that will allow water to flow through while preventing certain particles and/or solutes from passing through.

The efficacy of a membrane filtration process typically depends on the selectivity and flux, both of which are membrane dependent factors. Research has been performed to develop membranes with various pore sizes and geometries in order to achieve superior flux and selectivity. In addition, due to certain superior properties of biological membrane channel proteins that are known, there have also been discussions on the possibility to create a membrane that mimics the structure and functions of a biological membrane.

For example, certain water channel proteins that are integral membrane proteins, such as Aquaporins, are known to selectively allow the passage of water molecules across the plasma membrane in living cells, while preventing ions and other solutes from passing through. Their unique selectivity, high water transport capability, and low activation energy have garnered a significant amount of scientific interest. For instance, it has been reported that the osmotic permeability of a single aquaporin is in the range from 6×10⁻¹⁴ to 24×10⁻¹⁴ m³ s⁻¹ and that the permeability of an AQP-reconstituted biomimetic membrane can be two orders of magnitude greater than those of commercial polymeric membranes. Therefore, biomimetic membranes are seen as having high potential for water purification and desalination.

While attempts have been made to fabricate biomimetic membranes for water purification applications, the results obtained were far from desirable. A known method for fabricating these biomimetic membranes was to prepare planar pore-suspending bilayers. However, the ultrathin bilayers were found to be too fragile to withstand the pressures that are present during a typical membrane-based separation process.

To attempt addressing the stability and strength issues of such biomimetic membranes, some other processing methods were also employed but were still found to be inadequate in addressing the membrane strength problems. For example, S-layer proteins were used to stabilize the biomimetic lipid bilayers, but the increase of mechanical strength was mainly at the microscopic layer and was still insufficient for withstanding the pressure of a typical membrane-based separation process. Another example is the use of hydrogel encapsulation, which was also proposed to improve mechanical stabilization. However, it was reported that such hydrogel encapsulation adversely affects the life of the membrane bilayer that is used to incorporate aquaporins and the protein function may also be compromised during the hydrogel crosslinking process. Particularly, some of these known methods of preparing membranes also utilize high temperatures (for example, higher than 60° C.) that are capable of causing the denaturation of proteins, possibly rendering any water channel proteins incorporated in the membranes non-functional.

In view of the above, there is a need to provide a membrane and a method of making membranes that addresses or at least ameliorates the above drawbacks.

### SUMMARY

According to one aspect, there is provided a method of making a membrane, the method comprising coupling a vesicle to a support substrate, the vesicle comprising a plurality of water channels thereon; and partially embedding the vesicle coupled to the support substrate in a layer of material that is substantially impermeable to water to form the membrane.

In one embodiment, the step of coupling the vesicle to the support substrate comprises at least one of chemical coupling and physical adsorbing the vesicle to the support substrate.

In one embodiment, the support substrate comprises a porous substrate.

In one embodiment, the layer of material that is substantially impermeable to water is hydrophobic.

In one embodiment, the layer of material that is substantially impermeable to water comprises a polymer layer and the step of partially embedding the vesicle coupled to the support substrate in the polymer layer comprises:

providing a solution of monomers on the porous substrate to partially immerse the coupled vesicle in said solution; and polymerizing the monomers to form a layer of polymer such that the vesicle is partially embedded therein.

In one embodiment, the step of coupling the vesicle to the support substrate comprises reacting a first surface functional group of the vesicle with a second surface functional group of the support substrate to form a covalent bond.

In one embodiment, the water channels comprise aquaporin water channels.

In one embodiment, the method further comprise forming the vesicle having an amphiphilic membrane with a material that has a phase transition temperature no more than 60° C. prior to the step of coupling the vesicle to the support substrate.

In one embodiment, the material that has a phase transition temperature no more than 60° C. comprises unsaturated hydrocarbon groups.

According to another aspect, there is provided a method of making a membrane, the method comprising: forming a vesicle having an amphiphilic membrane with a lipid, a polymer or mixtures thereof that has a phase transition temperature no more than 60° C.; incorporating protein water channels into the amphiphilic membrane; coupling the vesicle onto a porous substrate membrane by chemically coupling the vesicle to the substrate and/or physically adsorbing the vesicle to the porous substrate; providing a solution of monomers on the porous substrate to partially immerse the coupled vesicle in said solution; and polymerizing the monomers to form a layer of polymer such that the vesicle is partially embedded therein, wherein the layer of polymer is substantially impermeable to water.

According to another aspect, there is provided a membrane for water filtration, the membrane comprising: a support substrate; a plurality of vesicles coupled to the support substrate, each vesicle comprising a plurality of water channels thereon; and a layer of material disposed over the support substrate that partially encapsulates the plurality of vesicles, wherein said layer of material is substantially impermeable to water.

In one embodiment, the layer of material that is substantially impermeable to water comprises a polymer layer.

In one embodiment, the polymer layer is selected from the group consisting of poly(ethylene glycol)dimethacrylate, polyalkylacrylate, polydiene, polyolefin, polylactone, polysiloxane, polyoxirane, polypyridine, polyvinylacetate, cellulose acetate, cellulose nitrate, polyvinylidine fluoride, polypropylene, polytetrafluoroethylene, polyethylene, polyvinylidenefluoride, polymethylpentene, polydimethylsiloxane, polybutadiene, polystyrene, polymethylmethacrylate, perfluoropolymer, polyetheretherketone, polyphenylene sulfide, liquid crystal polymers, polyimides, polyarylethersulfone, polyethersulfones, polysulfone, polymethylmethacrylate, polycarbonate, polyacrylonitrile, polyamide, and polytetrafluorethylene and copolymers thereof.

In one embodiment, the water channels are selectively permeable to allow water to pass through but substantially prevent one or more types of solutes from passing through, wherein the solutes comprises one or more ions selected from the group consisting of sodium, calcium, magnesium, potassium, borate, chloride, sulfate, bicarbonate, bromide, strontium, fluoride, and mixtures thereof.

In one embodiment, the water channels comprise aquaporin water channels.

In one embodiment, each of the vesicles comprises an amphiphilic membrane selected from the group consisting of a polymer, a lipid or mixtures thereof.

In one embodiment, the layer of material that is substantially impermeable to water has a thickness that is less than the average diameter of the vesicles.

In one embodiment, the layer of material that is substantially impermeable to water has a porosity of no more than about 30%.

In one embodiment, the vesicles have an average diameter of from 30 nanometers to 5 micrometers.

In one embodiment, the membrane has a sodium chloride rejection percentage from 20% to 99.9% when said membrane is used to separate sodium chloride from a feed solution comprising the sodium chloride, and wherein the sodium chloride rejection percentage is calculated by the formula,

$$Sodium\_Chloride \_rejection = ( 1 - \frac{( {C}_{f 0} {V}_{f 0} - {C}_{f 1} {V}_{f 1} ) / ( Δ {W}_{d} / {D}_{w} )}{{C}_{f 0}} ) \times 100 \%$$

where C_{f0} is a initial sodium chloride concentration of the feed solution (g/L); V_{f0} is a initial volume of the feed solution (L); C_{f1} is a final sodium chloride concentration of the feed solution (g/L); V_{f1} is a final volume of the feed solution (L); ΔW_{d} is either the weight increase of a permeate solution in hydraulic pressure driven filtration or the weight increase of a draw solution in a forward osmosis process (g); D_{w} is the density of water which is 1000 g/L.

In one embodiment, the membrane is capable of maintaining the sodium chloride rejection percentage in the range of from 20% to 99.9% when the filtration pressure is from 1 bar to 30 bars.

In one embodiment, the membrane is capable of maintaining the solute rejection percentage in the range of from 20% to 99.9% after more than two filtration cycles.

According to another aspect, there is provided a water filtration system comprising the membrane disclosed herein.

### DEFINITIONS

The term “vesicle” as used herein refers broadly to any fluid- or air-filled cavity, carrier, sac or enclosure that is formed naturally or synthetically. The term “vesicle” used herein includes, but is not limited to liposomes. For example, the vesicles of the present disclosure also include fluid- or air-filled cavities, carriers, sacs or enclosures that are formed from polymers. The vesicle of the present disclosure may be spherical, substantially spherical, or non-spherical, such as irregularly shaped particles or ellipsoidally shaped particles. The term “size” when used to refer to the vesicle broadly refers to the largest dimension of the particle. For example, when the vesicle is substantially spherical, the term “size” can refer to the diameter of the vesicle; or when the vesicle is substantially non-spherical, the term “size” can refer to the largest length of the vesicle.

The term “functional group” as used herein is to be interpreted broadly to refer to a group of atoms within a molecule responsible for a chemical characteristic of that molecule. In the present disclosure, where an entity is referred to as comprising a functional group, it should be appreciated that the functional group does not necessarily stand alone, but may form part of a larger molecule. A “functional group” may also be referred herein as a “chemical moiety”.

The term “functionalization” as used herein refers to, modification of an entity to provide one or more functional group on its surface.

The term “polymerisable group” as used herein refers to any functional group which is capable of reacting with another polymerisable group in a polymerisation reaction. A polymerisable group may be one that is capable of undergoing free radical polymerisation, for example an acrylate, methacrylate, acrylamide, methacrylamide or a vinyl group. The polymerisable group may be one that is capable of undergoing cation or anionic initiated polymerization, for example an ethenylbenzene or nitroethylene. The polymerisable group may be a one that is capable of undergoing ring-opening metathesis polymerisation, for example a norbornene or other strained cyclic alkene derivative.

The term “monomer” as used herein refers to a chemical entity that can be covalently linked to one or more of such entities to form an oligomer or a polymer.

The term “crosslinking” as used herein refers to the linking of at least two molecules, or two portions of a long molecule. Such linking may occur in many different ways including formation of a covalent bond, formation of hydrogen bonds, or through hydrophobic, hydrophilic, ionic or electrostatic interactions.

The term “hydrophobic” as used herein is intended to refer broadly to the characteristic of a material to be resistant to wetting, or not readily wet, by water, i.e., having a lack of affinity for water. Typically, the water contact angle of such materials is greater than 90°. Such materials may also include hydrophobic polymers. By way of examples only, such hydrophobic polymers may include polyolefins, such as polyethylene, poly(isobutene), poly(isoprene), poly(4-methyl-1-pentene), polypropylene, ethylenepropylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mole-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly(1-chlorodifluoromethyl)tetrafluoroethyl acrylate, poly di(chlorofluoromethyl)fluoromethyl acrylate, poly(1,1-dihydroheptafluorobutylacrylate), poly(1,1-dihydropentafluoroisopropylacrylate), poly(1,1-dihydropentadecafluorooctylacrylate), poly(heptafluoroisopropyl acrylate), poly 5-(heptafluoroisopropoxy)pentyl acrylate, poly 11-(heptafluoroisopropoxy)undecyl acrylate, poly 2-(heptafluoropropoxy)ethyl acrylate, and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly(t-nonafluorobutyl methacrylate); and polyesters, such a poly(ethylene terephthalate), poly(butylene terephthalate), and poly(ethylene terenaphthalate).

The term “micro” as used herein is to be interpreted broadly to include dimensions from about 1 micron to about 1000 microns.

The term “nano” as used herein is to be interpreted broadly to include dimensions less than about 1000 nm.

The term “particle” as used herein broadly refers to a discrete entity or a discrete body. The particle described herein can include an organic, an inorganic or a biological particle. Biological particles can include mammalian cell, blood cell, bacterial cell, cell organelle and virus. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle.

The terms “coupled” or “connected” as used in this description are intended to cover both directly connected or connected through one or more intermediate means, unless otherwise stated.

The term “microorganism” as used herein broadly refer to prokaryotic and eukaryotic microscopic organism such as a bacterium or protozoa, a virus or any kind of higher organism, such as a fungus, algae, a plant, or an animal.

The term “recombinant microorganism” and “recombinant host cell” used herein are interchangeable and includes microorganisms that have been genetically modified to express or over-express endogenous polynucleotides, or to express non-endogenous sequences, such as those included in a vector, or which have a reduction in expression of an endogenous gene. The polynucleotide generally encodes a target enzyme involved in a metabolic pathway for producing a desired metabolite as described above. Accordingly, recombinant microorganisms described herein include those that have been genetically engineered to express or over-express target enzymes not previously expressed or over-expressed by a parental microorganism. It will be appreciated that the terms “recombinant microorganism” and “recombinant host cell” refer not only to the particular recombinant microorganism but to the progeny or potential progeny of such a microorganism.

The term “optionally substituted” as used herein means the group to which this term refers may be unsubstituted, or may be substituted with one or more groups. Exemplary substituent groups include alkyl, alkenyl, alkynyl, thioalkyl, cycloalkyl, cycloalkenyl, heterocycloalkyl, halo, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphono and phosphinyl, aryl, heteroaryl, alkylaryl, alkylheteroaryl, cyano, cyanate, and isocyanate.

The term “associated with”, used herein when referring to two elements refers to a broad relationship between the two elements. The relationship includes, but is not limited to a physical, a chemical or a biological relationship. For example, when element A is associated with element B, elements A and B may be directly or indirectly attached to each other or element A may be produced by element B or vice versa.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Where applicable, conventional techniques of chemistry, molecular biology, genetic engineering, recombinant DNA, which are within the capabilities of a person of ordinary skill in the art, may be applied to assist the practice of one or more steps disclosed herein. The techniques may be available in texts such as Ausubel, F. M. et al. (1995 and periodic supplements; Current Protocols in Molecular Biology, ch. 9, 13, and 16, John Wiley & Sons, New York, N.Y.); B. Roe, J. Crabtree, and A. Kahn, 1996, DNA Isolation and Sequencing: Essential Techniques, John Wiley & Sons J. M. Polak and James O'D. McGee, 1990, In Situ Hybridization: Principles and Practice; Oxford University Press; J. Sambrook, E. F. Fritsch, and T. Maniatis, 1989, Molecular Cloning: A Laboratory Manual, Second Edition, Books 1-3, Cold Spring Harbor Laboratory Press; M. J: Gait (Editor), 1984, Oligonucleotide Synthesis: A Practical Approach, Id Press; D. M. J. Lilley and J. E. Dahlberg, 1992, Methods of Enzymology: DNA Structure Part A: Synthesis and Physical Analysis of DNA Methods in Enzymology, Academic Press; and Lab Ref: A Handbook of Recipes, Reagents, and Other Reference Tools for Use at the Bench, Edited Jane Roskams and Linda Rodgers, 2002, Cold Spring Harbor Laboratory, ISBN 0-87969-630-3.

### DESCRIPTION OF EMBODIMENTS

Exemplary, non-limiting embodiments of a membrane for water filtration and a method of making such a membrane are disclosed hereinafter.

The membrane for water filtration may comprise a support substrate; a plurality of vesicles coupled to the support substrate, each vesicle comprising a plurality of water channels thereon; and a layer of material disposed over the support substrate that partially encapsulates the plurality of vesicles, wherein said layer of material is substantially impermeable to water. In some embodiments, the layer of material is completely impermeable to water. In some embodiments, the layer of material substantially prevents water from passing from one side of the membrane to the opposite side without passing through the water channels. For example, the layer of material may substantially prevent water from passing from the side of the membrane closest to the vesicle to the side of the membrane closest to the porous substrate without passing through the water channels or vice versa.

The layer of material may partially encapsulate a vesicle such that at least about 10%, at least about 20%, at least about 30%, at least about 40%, at least about 50%, at least about 60%, at least about 70%, at least about 80%, at least about 90% of the vesicle is encapsulated or embedded in the layer of material. In one embodiment, the no more than about 80%, no more than about 70%, no more than about 60%, no more than about 50% of the vesicle is encapsulated or embedded in the layer of material.

In one embodiment, the layer of material disposed over the support substrate disclosed herein is hydrophobic. The hydrophobicity of the material may be an inherent property of the material. Alternatively, the hydrophobicity of the material may be due to a hydrophobic coating being applied to the material. In some embodiments, the hydrophobicity of the material is due to the inherent property of the material as well as a hydrophobic coating being applied onto the material. In one embodiment, the material has a hydrophobicity that is higher than hydrogel. Accordingly, in some embodiments, the layer of material does not comprise gel such as hydrogel or excludes a gel such as hydrogel. In one embodiment, the layer of material is not derived from a gel.

In one embodiment, the layer of material disposed over the support substrate disclosed herein comprises a polymer layer. The polymer may be a hydrophobic polymer. The polymer layer may be selected from the group consisting of polyalkylacrylate, polydiene, polyolefin, polylactone, polysiloxane, polyoxirane, polypyridine, polyvinylacetate, cellulose acetate, cellulose nitrate, polyvinylidine fluoride, polypropylene, polytetrafluoroethylene, polyethylene, polyvinylidenefluoride, polymethylpentene, polydimethylsiloxane, polybutadiene, polystyrene, polymethylmethacrylate, perfluoropolymer, polyetheretherketone, polyphenylene sulfide, liquid crystal polymers, polyimides, polyarylethersulfone, polyethersulfones, polysulfone, polymethylmethacrylate, polycarbonate, polyacrylonitrile, polyamide, and polytetrafluorethylene and copolymers thereof. The polymer may be a product of chain polymerization or a product of step polymerization. The chain polymerization may be a free radical polymerization, a cation initiated polymerization, an anion initiated polymerization, or coordination polymerization. Additionally, the polymer may be a product of photopolymerization, or heat-activated polymerization, or oxidation-reduction activated polymerization.

In another embodiment, the polymer is a product of free radical polymerization of one or more monomers. Examples of monomers, include, but are not limited to methyl methacrylate, ethylene glycol diacrylate, ethylene glycol dimethacrylate (EGDMA), acrylonitrile and acrylamide, diethylene glycol diacrylate, diethylene glycol dimethacrylate, 1,4-butanediol diacrylate, 1,4-butanediol dimethacrylate, 1,6-hexanediol diacrylate, 1,6-hexanediol dimethacrylate, trimethylolpropane triacrylate, trimethylolpropane trimethacrylate, or blends thereof. In one embodiment, the polymer comprises poly(ethylene glycol)dimethacrylate.

The layer of material disposed over the support substrate disclosed herein may be a dense layer having a porosity range of no more than about 30%, no more than about 25%, no more than about 20%, no more than about 15%, no more than about 10%, or no more than about 5%. In one embodiment, the layer of material has a thickness that is less than the average particle size of the vesicles.

Advantageously, this allows part of the vesicles to be exposed to the external environment and not be encapsulated by the layer of material. In one embodiment, the layer of material spans across two or more vesicles thereby substantially covering the gaps or spaces between the vesicles.

In one embodiment, the layer of material has a cross-sectional thickness from about 10 nm to about 5 μm, from about 20 nm to about 4 μm, from about 30 nm to about 3 μm, from about 40 nm to about 2 μm, from about 50 nm to about 1 μm, from about 100 nm to about 5 μm, from about 150 nm to about 5 μm, from about 200 nm to about 5 μm, from about 300 nm to about 5 μm, from about 400 nm to about 5 μm, from about 500 nm to about 5 μm, from about 600 nm to about 5 μm, from about 700 nm to about 5 μm, from about 800 nm to about 5 μm, from about 900 nm to about 5 μm, or from about 1 μm to about 5 μm. The layer of material disposed over the support substrate may also be partially incorporated in the support substrate during the polymerization reaction, for example such that the support substrate is partially entrained or impregnated in the layer of material or vice versa. Advantageously, this may allow the layer of material to be securely anchored on the support substrate.

The vesicles may be anchored, secured and/or immobilized on the substrate through chemical interactions and/or physical interactions such as physical adsorption. Exemplary types of physical interactions or physical adsorption include, but are not limited to Van der Waals interaction, electrostatic interaction, hydrophobic interaction, dipole interaction, hydrogen bonding forces, magnetic attraction, and/or adsorption via pressure/vacuum. In one embodiment, the vesicles are chemically coupled to the support substrate via a covalent bond. The chemical coupling of the vesicles to the support substrate may be directly or indirectly through one or more linkers. In one embodiment, the vesicles disclosed herein are coupled to the support substrate via a first surface functional group on the vesicles and a second surface functional group on the support substrate. The first and second functional groups may be any functional groups that allow a conjugation reaction to take place to couple the vesicle to the support substrate.

The first functional group and/or the second functional group may be independently selected from the group consisting of alkenyl, alkynyl, benzyl bromide, halo, fluoro, chloro, bromo, iodo, hydroxyl, carbonyl, aldehyde, haloformyl, carbonate ester, carboxylate, carboxyl, ester, methoxy, hydroperoxy, peroxy, ether, hemiacetal, hemiketal, primary/secondary/tertiary amine, 4° ammonium ion, primary/secondary ketimine, primary/secondary aldimine, imide, azide, azo, cyanate, isocyanate, nitrate, nitrile, isonitrile, nitrosooxy, nitro, nitroso, pyridyl, sulphydryl, sulfide, disulfide, sulfinyl, sulfonyl, sulfino, sulfo, thiocyanate, isothiocyanate, carbonothioyl, carbonothioyl, phosphono, borono, borino, acyl chloride, phosphorodiester, thiophosphorodiester, aminooxy, carbonate, carbamate, hydrazone, oxime halogen, epoxide, hydrazide, maleimide, succinimidyl glutarate, succimidyl succinate, succinic acid and tresylate. In one embodiment, the first functional group comprises a carboxyl acid group and the second functional group comprises an amine group. In one embodiment, the vesicles may be coupled to the support substrate via an amide bond.

The coupling of the vesicles to the support substrate may be a direct connection of the vesicle to the substrate or a connection of the vesicle to the substrate through one or more intermediate linkers. Therefore, the linker may also comprise one or more functional groups selected from the group consisting of alkenyl, alkynyl, benzyl bromide, halo, fluoro, chloro, bromo, iodo, hydroxyl, carbonyl, aldehyde, haloformyl, carbonate ester, carboxylate, carboxyl, ester, methoxy, hydroperoxy, peroxy, ether, hemiacetal, hemiketal, primary/secondary/tertiary amine, 4° ammonium ion, primary/secondary ketimine, primary/secondary aldimine, imide, azide, azo, cyanate, isocyanate, nitrate, nitrile, isonitrile, nitrosooxy, nitro, nitroso, pyridyl, sulphydryl, sulfide, disulfide, sulfinyl, sulfonyl, sulfino, sulfo, thiocyanate, isothiocyanate, carbonothioyl, carbonothioyl, phosphono, borono, borino, acyl chloride, phosphorodiester, thiophosphorodiester, aminooxy, carbonate, carbamate, hydrazone, oxime halogen, epoxide, hydrazide, maleimide, succinimidyl glutarate, succimidyl succinate, succinic acid and tresylate.

In one embodiment, the water channels are selectively permeable to allow water to pass through but substantially prevent one or more types of solutes from passing through. The solutes may be salts or ions thereof. In one embodiment, the solutes comprise metal salts. The solutes may comprise one or more ions selected from the group consisting of sodium, calcium, magnesium, potassium, borate, chloride, sulfate, bicarbonate, bromide, strontium, fluoride, and mixtures thereof. In one embodiment, the water channels are selectively permeable to allow water to pass through but substantially prevent contaminants from passing through. Contaminants may include unwanted particles, microorganisms, minerals, proteins, nucleic acids, detergents or mixtures thereof.

In one embodiment, the water channels are transmembrane water channels. In one embodiment, the water channels comprise protein water channels. The water channels may comprise aquaporin water channels. The water channels may be derived from mammalian aquaporin families or bacterial aquaporin families. In one embodiment, the aquaporin water channel is Aquaporin 0. In one embodiment, the aquaporin water channels are bacteria-derived aquaporin water channels. For example, the bacteria-derived aquaporin water channels may be Aquaporin-z (AQPz) water channel. In one embodiment, the protein water channels are harvested from microorganism cells. The microorganism may be a recombinant microorganism comprising an exogenous gene sequence encoding for the protein water channel. In one embodiment, the protein water channels are harvested from bacteria cells.

In one embodiment, the membrane of the vesicle disclosed herein comprises hydrophobic and hydrophilic parts. The vesicle may comprise an amphiphilic membrane or an amphipathic membrane. The membrane may be formed of a material that has a phase transition temperature of no more than about 60° C., no more than about 55° C., no more than about 50° C., no more than about 45° C., no more than about 40° C., no more than about 39° C., no more than about 38° C., no more than about 37° C., no more than about 36° C. or no more than about 35° C. In one embodiment, the material comprises unsaturated hydrocarbon groups. The unsaturated hydrocarbon groups may be alkenes, alkynes or mixtures thereof.

In one embodiment, the membrane of the vesicle disclosed herein comprises a polymer, a lipid or mixtures thereof. The polymer may be an amphiphilic polymer.

The amphiphilic polymer may be a block copolymer comprising at least one hydrophilic block and at least one hydrophobic block. Examples of hydrophilic blocks include, but are not limited to, polyethylene glycol), poly(2-methyloxazoline), poly(2-ethyl oxazoline), polyacrylates, polyacrylic acid, polyvinyl pyrrolidone, polynucleotides, poly(hydroxyethyloxazoline), polynucleic acid, poly(hydroxyethylmethacylate), polyallylamine, polyaminoacids, and polysaccharides, chitosan, or poly(dimethylaminoethyl methacylate). Examples of hydrophobic blocks, include, but are not limited to, polydimethylsiloxane, polybutadiene, poly(caprolactone, poly(lactide), poly(methyl methacrylate), polydiphenylsiloxane, perfluoropolyether, polystyrene, polyoxypropylene, polyvinylacetate, polyoxybutylene, polyisoprene, polyvinylchloride, polyalkylacrylate, polyalkylmethacrylate, polyacrylonitrile, polypropylene, polyvinylethers, and poly(propylene oxide). In one embodiment, the membrane of the vesicle comprises a tri-block copolymer. In one embodiment, the tri-block copolymer comprises poly(2-methyloxazoline)-block-poly(dimethylsiloxane)-block-poly(2-methyloxazoline). In one embodiment, the lipid comprises a phospholipid. The polymer or lipid of the membrane of the vesicles may also be crosslinkable or capable of forming crosslinks with itself or with one another. Advantageously, this improves the mechanical strength of the vesicle. The vesicles may have an average size of from about 30 nm to about 5 μm, from about 30 nm to about 4 μm, from about 30 nm to about 3 μm, from about 40 nm to about 2 μm, from about 50 nm to about 1 μm, from about 100 nm to about 5 μm, from about 150 nm to about 5 μm, from about 200 nm to about 5 μm, from about 300 nm to about 5 μm, from about 400 nm to about 5 μm, from about 500 nm to about 5 μm, from about 600 nm to about 5 μm, from about 700 nm to about 5 μm, from about 800 nm to about 5 μm, from about 900 nm to about 5 μm, or from about 1 μm to about 5 μm. In one embodiment, the average number of water channels per vesicle is from about 20 to about 100000, from about 50 to about 90000, from about 100 to about 50000, from about 500 to about 1000, or from about 1000 to about 70000. The membrane of the vesicles may have a thickness that is sufficiently thick to work as a barrier to substantially prevent solute diffusion through the vesicle membrane. The thickness of the vesicle membrane may be from about 3 nm to about 30 nm, from about 4 nm to about 25 nm, from about 5 nm to about 20 nm, from about 6 nm to about 15 nm, from about 7 nm to about 10 nm, from about 8 nm to about 26 nm, from about 9 nm to about 28 nm, or from about 10 nm to about 30 nm.

The support substrate disclosed herein may be comprised of any material that is able to be coupled or modified to be coupled to the vesicle disclosed herein. Examples of support substrate that may be suitable, include, but are not limited to a cellulose acetate substrate, a nitrocellulose substrate, a cellulose esters substrate, a polycarbonate substrate, a polyamine substrate, a polyimide substrate, a polysulfone substrate, a polyether sulfone substrate, a polyacrilonitrile substrate, a polyethylene substrate, a polypropylene substrate, a polytetrafluoroethylene substrate, a polyvinylidene fluoride substrate, a polyvinylchloride substrate, a polyterepthalate substrate, an alumina oxide substrate, a titania oxide substrate, a zirconia oxide substrate, a perovskite-type oxides substrate and mixtures thereof. In one embodiment, the support substrate is one that can be functionalized with one or more of the functional groups disclosed herein.

In one embodiment, the support substrate is capable of allowing water and one or more solutes described herein to pass through. In another embodiment, the support substrate is selectively permeable to allow water to pass through but substantially prevents one or more types of solutes from passing through. The solutes may be metal salts. In one embodiment, the support substrate is hydrophilic. Advantageously, this can facilitate the flow of water from through the vesicles to the support substrate. In one embodiment, the support substrate comprises a porous substrate. The porous substrate may also have a pore density of from about 5% to about 90%, from about 10% to about 85%, from about 15% to about 80%, from about 20% to about 75%, from about 25% to about 70%, from about 30% to about 65%, from about 35% to about 60%, from about 40% to about 55%, or from about 50% to about 90%. The porous substrate may have an average pore size of from about 5 nm to about 200 nm, from about 10 nm to about 150 nm, from about 15 nm to about 100 nm, from about 20 nm to about 100 nm, from about 25 nm to about 100 nm, from about 50 nm to about 100 nm, from about 60 nm to about 100 nm, from about 70 nm to about 160 nm, from about 80 nm to about 180 nm, from about 25 nm to about 200 nm. In one embodiment, the average pore size of the porous substrate is no more than about 100 nm. In one embodiment, the support substrate comprises a symmetrical-pore structured substrate membrane. In another embodiment, the support substrate comprises an asymmetrical-pore structured substrate membrane. The asymmetrical-pore structured substrate membrane may comprise a skin layer with smaller pores and a bulk layer with larger pores. Accordingly, the average pore size disclosed above may be related to the pores in the skin layer. In one embodiment, the pores of the porous substrate are selectively permeable to allow water to pass through but substantially prevent contaminants from passing through. Contaminants may include unwanted particles, microorganisms, minerals, proteins, nucleic acids, detergents or mixtures thereof.

In one embodiment, the support substrate disclosed herein has a sodium chloride rejection percentage from about 0% to about 20%, from about 5% to about 15%, from about 10% to about 20%, from about 0% to about 10%, from about 2% to about 18%, from about 4% to about 16%, or from about 0% to about 15% when said membrane is used to separate sodium chloride from a feed solution comprising the sodium chloride, and wherein the sodium chloride rejection percentage is calculated by the formula,

$$Sodium\_Chloride \_rejection = ( 1 - \frac{( {C}_{f 0} {V}_{f 0} - {C}_{f 1} {V}_{f 1} ) / ( Δ {W}_{d} / {D}_{w} )}{{C}_{f 0}} ) \times 100 \%$$

where C_{f0} is a initial sodium chloride concentration of the feed solution (g/L); V_{f0} is a initial volume of the feed solution (L); C_{f1} is a final sodium chloride concentration of the feed solution (g/L); V_{f1} is a final volume of the feed solution (L); ΔW_{d} is the weight increase of a permeate solution in hydraulic pressure driven filtration or the weight increase of a draw solution in a forward osmosis process (g); D_{w} is the density of water which is 1000 g/L. The membrane may be used to separate the feed solution and the draw solution in the forward osmosis process such that the feed solution may be placed at the side of the membrane that is nearer the layer of material substantially impermeable to water while the draw solution may be placed at the side of the membrane that nearer support substrate. The feed solution may be one that has a higher concentration of sodium chloride when compared to the draw solution. The draw solution may be one that has a higher concentration of osmotic pressure compared to the feed solution.

In one embodiment, the membrane disclosed herein has a sodium chloride rejection percentage from about 20% to about 99.9%, from about 25% to about 95%, from about 30% to about 90%, from about 40% to about 85%, from about 50% to about 80%, from about 60% to about 75%, or from about 70% to about 99.9%.

In one embodiment, the support substrate disclosed herein has a magnesium chloride rejection percentage from about 0% to about 20%, from about 5% to about 15%, from about 10% to about 20%, from about 0% to about 10%, from about 2% to about 18%, from about 4% to about 16%, or from about 0% to about 15% when said membrane is used to separate magnesium chloride from a feed solution comprising the magnesium chloride, and wherein the magnesium chloride rejection percentage is calculated by the formula,

$$Magnesium\_Chloride \_rejection = ( 1 - \frac{( {C}_{f 0} {V}_{f 0} - {C}_{f 1} {V}_{f 1} ) / ( Δ {W}_{d} / {D}_{w} )}{{C}_{f 0}} ) \times 100 \%$$

where C_{f0} is a initial magnesium chloride concentration of the feed solution (g/L); V_{f0} is a initial volume of the feed solution (L); C_{f1} is a final magnesium chloride concentration of the feed solution (g/L); V_{f1} is a final volume of the feed solution (L); ΔW_{d} is the weight increase of a permeate solution in hydraulic pressure driven filtration or the weight increase of a draw solution in a forward osmosis process (g); D_{w} is the density of water which is 1000 g/L. The membrane may be used to separate the feed solution and the draw solution in the forward osmosis process such that the feed solution may be placed at the side of the membrane that is nearer the layer of material substantially impermeable to water while the draw solution may be placed at the side of the membrane that nearer support substrate. The feed solution may be one that has a higher concentration of the magnesium chloride when compared to the draw solution. The draw solution may be one that has a higher osmotic pressure compared to the feed solution. The draw solution may be one that has a higher concentration of osmotic pressure compared to the feed solution.

In one embodiment, the membrane disclosed herein has a magnesium chloride rejection percentage from about 20% to about 99.9%, from about 25% to about 95%, from about 30% to about 90%, from about 40% to about 85%, from about 50% to about 80%, from about 60% to about 75%, or from about 70% to about 99.9%.

In one embodiment, the membrane is capable of maintaining the sodium chloride and/or magnesium chloride rejection percentage in the range of from about 20% to about 99.9%, from about 25% to about 95%, from about 30% to about 90%, from about 40% to about 85%, from about 50% to about 80%, from about 60% to about 75%, or from about 70% to about 99.9% and/or the water permeability in the range of from about 0.1 LMH/bar to about 50 LMH/bar, when the filtration pressure is from about 1 bar to about 30 bars, from about 5 bar to about 10 bars, from about 10 bar to about 25 bars, from about 15 bar to about 30 bars, from about 20 bar to about 30 bars.

In one embodiment, the membrane has a water flux of from 0.5 LMH to 200 LMH based on a 200 ppm NaCl feed solution and a 0.3 mol/L sucrose draw solution. In one embodiment, the membrane has a NaCl flux of less than 1 g m⁻² h⁻¹ based on a 200 ppm NaCl feed solution and a 0.3 mol/L sucrose draw solution.

The membrane disclosed herein may also be used more than once without substantial loss of filtration properties. In one embodiment, the membrane is capable of being reused or recycled for at least 2 times without substantial loss of filtration properties. The membrane may be capable of maintaining the sodium chloride rejection performance in the range of from about 50% to about 100%, from about 55% to about 95%, from about 60% to about 90%, from about 65% to about 85%, from about 70% to about 80%, or from about 75% to about 100% of the salt or solute rejection in the first filtration cycle after more than one filtration cycle or after more than two filtration cycles. In one embodiment, the membrane is capable of being reused or recycled for at least once, at least twice or at least three times, such that the solute rejection percentage does not change more than about 50%, or about 40%, or about 30% or about 20% of its original value.

In one embodiment, the membrane disclosed herein is substantially planar. The membrane disclosed herein may be a biomimetic membrane. There is also provided herein a water desalination system or a water purification system or a water filtration system comprising the membrane disclosed herein.

There is provided herein a method of making a membrane. The method may comprise coupling a vesicle to a support substrate, the vesicle comprising a plurality of water channels; and partially embedding the vesicle coupled to the support substrate in a layer of material that is substantially impermeable to water to form the membrane. The membrane may have one or more of the properties or features discussed above. Accordingly, the support substrate, the vesicle, water channel, layer of material that is substantially impermeable to water may have one or more of the properties or features discussed above.

In one embodiment, when the layer of material that is substantially impermeable to water is comprised of a polymer, the step of partially embedding the vesicle coupled to the support substrate in the polymer layer comprises providing a solution of monomers on the support substrate to partially immerse the coupled vesicle in said solution; and polymerizing the monomers to form a layer of polymer such that the vesicle is partially embedded therein. The step of providing a solution of monomers on the support substrate may further comprise providing one or more polymerization initiators on the support substrate. The initiators may be any kind of initiators that are required for the polymerization reaction. The initiators may be selected from the group consisting of diatomic molecules, halogens, Azo compounds, organic and inorganic peroxides, protonic acid, Lewis acids/friedel-crafts catalysts, carbenium ion salts, alkali metal aromatic anion salts, peroxides combined with a reducing agent such as Cr²⁺/V²⁺/Ti³⁺/Co²⁺/Cu⁺/Fe²⁺, inorganic reductants such as HSO₃⁻/SO₃²⁻/S₂O₃²⁻/S₂O₅²⁻ combined with inorganic oxidants such as Ce⁴⁺/V⁵⁺/Cr⁶⁺/Mn³⁺/Ag⁺/Cu²⁺/Fe³⁺/ClO₃⁻/H₂O₂, peroxydiphosphates, alcohol combined with oxidants, and mixtures thereof.

The polymerization step may be carried out at a temperature of no more than about 50° C., no more than about 45° C., no more than about 44° C., no more than about 43° C., no more than about 42° C., no more than about 41° C., no more than about 40° C., no more than about 39° C., no more than about 38° C., no more than about 37° C., no more than about 36° C., or no more than about 35° C. In one embodiment, the polymerization step is carried out at a temperature of from about 0° C. to about 90° C., from about 10° C. to about 80° C., from about 20° C. to about 70° C., from about 30° C. to about 60° C., from about 35° C. to about 50° C., or from about 25° C. to about 45° C. In one embodiment, the polymerization is an in situ polymerization.

The step of coupling the vesicle to the support substrate may comprise chemically coupling the vesicle to the support substrate, physically adsorbing the vesicle to the support substrate or both. The chemically coupling may comprise reacting a first surface functional group of the vesicle with a second surface functional group of the porous substrate to form a covalent bond. In one embodiment, the step of chemically coupling the vesicle to the porous substrate may be carried out in the presence of one or more catalysts. The catalyst may be selected from the group consisting of 1-Ethyl-3-[3-dimethylaminopropyl]carbodiimide hydrochloride (EDC), N-hydroxysulfosuccinimide (NHS) and mixtures thereof. Other types of catalyst may also be used depending on the types of functional groups involved in the chemical coupling step that are present. In some other embodiments, the step of chemically coupling the vesicles to the porous substrate is carried out in the absence of any catalysts. In one embodiment, the step of chemically coupling the vesicle to the porous substrate is carried out in a water phase.

The method may also further comprise functionalizing the vesicle with a first surface functional group and functionalizing the support substrate with a second surface functional group prior to the coupling step. In one embodiment, the step of functionalizing the vesicle with the second surface functional group comprises introducing a supporting functional group on the support substrate before modifying the supporting functional group to form the second surface functional group on the support substrate. The first, second surface functional group and/or supporting functional group may be independently selected from those functional groups discussed herein. In one embodiment, the supporting functional group is an aldehyde group and the second functional group is an amine group, for example a primary amine group.

In one embodiment, the method disclosed herein further comprise forming the vesicle having an amphiphilic membrane with a material that has a phase transition temperature no more than about 60° C., no more than about 55° C., no more than about 50° C., no more than about 45° C., no more than about 40° C., or no more than about 37° C., prior to the step of coupling the vesicle to the support substrate. The material that has a phase transition temperature no more than 60° C. comprises unsaturated hydrocarbon groups. The amphiphilic membrane may comprise a polymer, a lipid or mixtures thereof that are disclosed herein. The step of forming the vesicle having the amphiphilic membrane may also comprise extruding the vesicles with a sieve to achieve vesicles with a size distribution of from about 30 nm to about 5 μm, from about 30 nm to about 4 μm, from about 30 nm to about 3 μm, from about 40 nm to about 2 μm, from about 50 nm to about 1 μm, from about 100 nm to about 5 μm, from about 150 nm to about 5 μm, from about 200 nm to about 5 μm, from about 300 nm to about 5 μm, from about 400 nm to about 5 μm, from about 500 nm to about 5 μm, from about 600 nm to about 5 μm, from about 700 nm to about 5 μm, from about 800 nm to about 5 μm, from about 900 nm to about 5 μm, or from about 1 μm to about 5 μm. The sieve may comprise a polycarbonate membrane.

The method may comprise incorporating the water channels into the amphiphilic membrane prior to the coupling step. In one embodiment, the step of incorporating the water channels into the amphiphilic membrane comprises incubating water channels with the amphiphilic membrane in the presence of a detergent to incorporate the water channels therein. The detergent may be dodecyl-β-d-maltoside or Octyl glucoside. The detergent may be subsequently removed by dialysis or from the use of biobeads such as polystyrene beads. In one embodiment, after the step of extruding the vesicles, the method further comprises crosslinking the vesicles. The crosslinking step may be carried out in the presence of heat and/or light irradiation, for example ultraviolet light irradiation.

The method disclosed herein may also comprise culturing a microorganism having a gene sequence encoding a protein water channel and harvesting the protein water channel from the micro-organism expressing the protein water channel. This may be carried out prior to the step of incorporating the water channels into the membrane of the vesicles. The microorganism may be a bacteria cell.

In one embodiment, the method disclosed herein may also comprise identifying a gene sequence encoding a protein water channel and introducing the gene sequence in a host cell to obtain a recombinant host cell that is capable of expressing the protein water channel. The step of introducing may comprise the use of vectors. Accordingly, the identified exogenous gene may be prepared and inserted into an expression vector, which may be then transfected into a host cell, which may be then grown under culture conditions suitable for expressing the exogenous gene. Appropriate culture conditions are conditions of culture medium pH, ionic strength, nutritive content, etc.; temperature; oxygen/CO₂/nitrogen content; humidity; and other culture conditions that permit production of the compound by the host microorganism, i.e., by the metabolic action of the microorganism.

In some embodiments, the microorganisms can be cultured in a bioreactor. The bioreactor can be used to culture microorganism cells through the various phases of their physiological cycle. Bioreactors may also allow for the control of one or more culture conditions such as temperature, pH, oxygen tension, carbon dioxide levels, and the like, as well as combinations thereof. Cells may also be cultured in shake flasks, test tubes, vials, microtiter dishes, petri dishes, or the like, or combinations thereof.

In one embodiment, there is provided a method of making a membrane, the method comprising forming a vesicle having an amphiphilic membrane with a lipid, a polymer or mixtures thereof that has a phase transition temperature no more than 60° C.; incorporating protein water channels into the amphiphilic membrane; coupling the vesicle to a porous substrate membrane by chemically coupling the vesicle to the substrate and/or physically adsorbing the vesicle to the porous substrate; providing a solution of monomers on the porous substrate to partially immerse the coupled vesicle in said solution; and polymerizing the monomers to form a layer of polymer such that the vesicle is partially embedded therein, wherein the layer of polymer is substantially impermeable to water.

In one embodiment, there is also provided a method of purifying water, the method comprising the step of passing unpurified water through the membrane disclosed herein to obtain substantially purified water. In another embodiment, there is also provided a method of removing solutes from water, the method comprising the step of passing water containing solutes therein through the membrane disclosed herein to obtain water substantially free from the solutes.

### BRIEF DESCRIPTION OF FIGURES

FIG. 1 is a cross-sectional schematic representation of a membrane in accordance with one embodiment disclosed herein.

FIG. 2 is a flowchart of a method of making a membrane in accordance with one embodiment disclosed herein.

FIG. 3 shows the Nuclear Magnetic Resonance (NMR) images of the block copolymers in accordance with some embodiments disclosed herein.

FIG. 4 is a schematic representation of a step of incorporating water channels into the vesicles in accordance with one embodiment disclosed herein.

FIG. 5 shows confocal microscopy micrographs of non-extruded proteopolymersomes in accordance with one embodiment disclosed herein.

FIG. 6a is a transmission electron microscopy (TEM) image showing the morphology of extruded polymer vesicles in accordance with one embodiment is disclosed herein.

FIG. 6b is a graph showing the polymer vesicle size distribution of the vesicles of FIG. 6a, measured by dynamic light scattering (DLS).

FIG. 7 is a graph showing Fourier Transform Infra Red (FTIR) spectra of polymer vesicles in accordance with one embodiment disclosed herein, with UV irradiation for 15 minutes and without UV irradiation.

FIG. 8 is a graph comparing the water permeability of vesicles in accordance with one embodiment disclosed herein and water permeability of blank vesicles, characterized by a stopped-flow apparatus.

FIG. 9 is a graph showing the effect of increasing the amount of AQPz on the vesicle permeability in accordance with one embodiment disclosed herein.

FIG. 10 is a bar chart diagram showing the vesicle permeabilities of different embodiments of the vesicle disclosed herein.

FIG. 11 is a graph showing Fourier Transform Infra Red (FTIR) of (a) cellulose acetate substrate before aldehyde functionalization in accordance with one embodiment disclosed herein and of (b) cellulose acetate substrate after aldehyde functionalization in accordance with one embodiment disclosed herein.

FIG. 12 is a schematic representation of a method of making a membrane in accordance with one embodiment disclosed herein.

FIG. 13 is a graph showing the profile of nanofiltration performance as a function of the imprinting polymerization duration of non-vesicle imprinted membranes.

FIG. 14a and FIG. 14b are field emission scanning electron microscopy (FESEM) images showing respectively the top surface and cross sectional membrane morphologies of a cellulose acetate porous substrate in accordance with one embodiment disclosed herein.

FIG. 14c and FIG. 14d are field emission scanning electron microscopy (FESEM) images showing respectively the top surface and cross sectional membrane morphologies of a non-vesicle-imprinted membrane in accordance with one embodiment disclosed herein.

FIG. 14e and FIG. 14f are field emission scanning electron microscopy (FESEM) images showing respectively the top surface and cross sectional membrane morphologies of an AQPz-vesicle-imprinted membrane in accordance with one embodiment disclosed herein.

FIG. 15 is a Scanning Electron Microscopy (SEM) image of the morphology of AQPz-vesicle-imprinted membrane after nanofiltration test in accordance to one embodiment disclosed herein.

FIG. 16 is a graph showing salt rejection properties and water flux of an AQP-incorporated membrane in nanofiltration when the membrane is being reused in accordance with one embodiment disclosed herein.

FIG. 17 is a schematic diagram of a forward osmosis permeation cell in accordance with one embodiment disclosed herein.

FIG. 18 is a schematic diagram showing the water purification mechanism for an AQPz-vesicle-imprinted membrane in accordance with one embodiment disclosed herein.

FIG. 19 is a schematic diagram of a membrane in different stages of preparation in accordance with one embodiment disclosed herein.

### DETAILED DESCRIPTION OF FIGURES

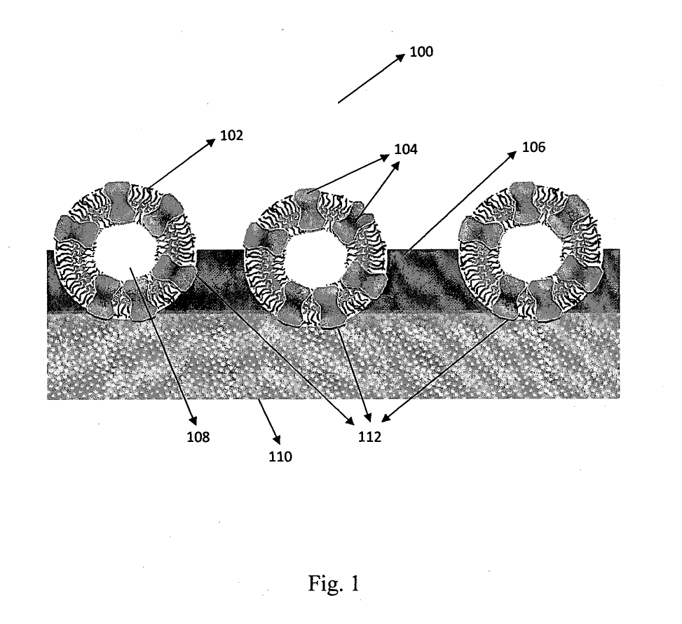

Referring to FIG. 1, there is shown a cross-sectional schematic representation of membrane 100, in the form of a protein-incorporated vesicular membrane in accordance with one embodiment of the membrane disclosed herein. The membrane 100 comprises a porous substrate 110, a plurality of vesicles 112 that is chemically coupled to the substrate 110 and a layer of material 106 disposed over the porous substrate 110 that partially encapsulates the plurality of vesicles 112. The layer of material 106 is substantially impermeable to water. Each of the vesicles 112 also comprises a plurality of water channels 104 thereon. The water channels 104 are incorporated in the membrane 102 of the vesicles 112. The vesicle also encapsulates a space 108 therewithin.

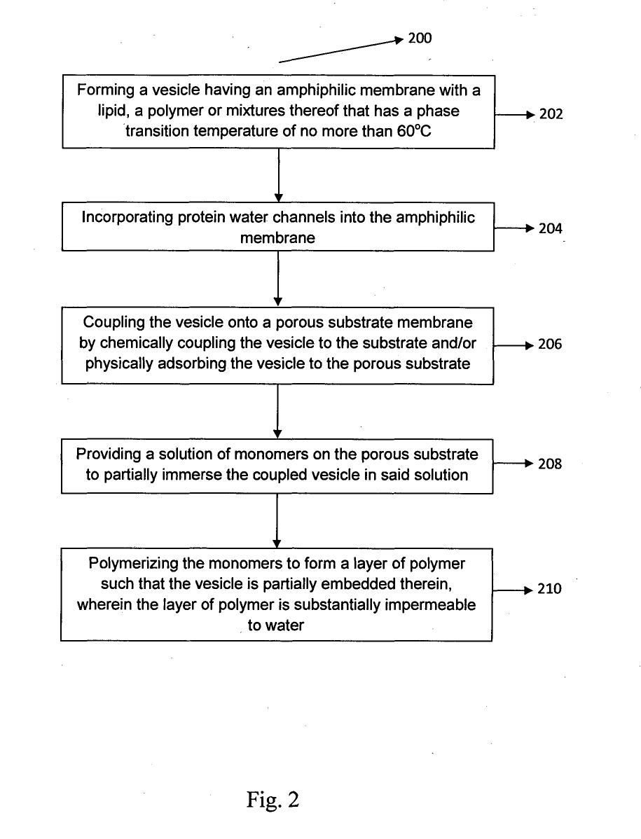

Referring to FIG. 2, there is shown a flowchart 200 of a method of making a membrane in accordance with one embodiment disclosed herein. In step 202, a vesicle having an amphiphilic membrane is first formed with a lipid, a polymer or mixtures thereof that has a phase transition temperature of no more than 60° C. Thereafter, in step 204, protein water channels are incorporated into the amphiphilic membrane obtained from step 202. Next, in step 206, the vesicle is coupled to the porous substrate by chemically coupling the vesicle to the substrate and/or physically adsorbing the vesicle to the porous substrate. Thereafter, in step 208, a solution of monomers is provided on the porous substrate to partially immerse the coupled vesicle in said solution. In step 210, the monomer solution is then polymerized to form a layer of polymer such that the vesicle is partially embedded therein and wherein the layer of polymer is substantially impermeable to water.

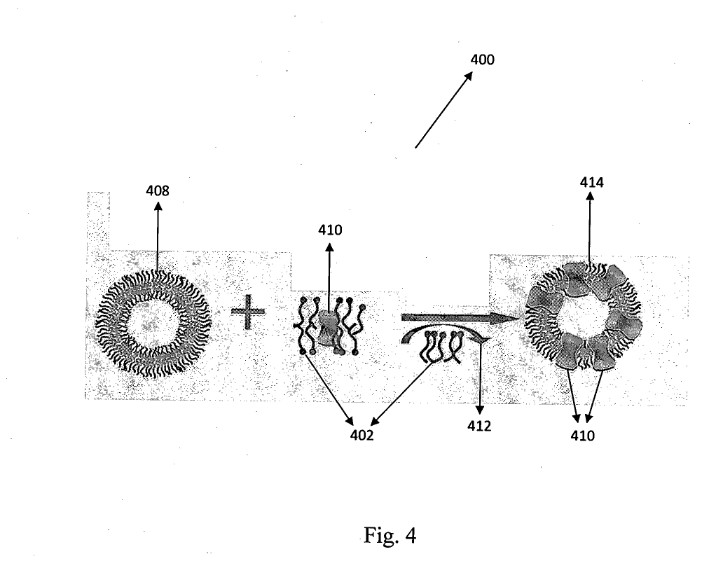

Turning now to FIG. 4, there is shown a schematic representation of a step 400 of reconstituting water channels into the vesicles in accordance with one embodiment disclosed herein. In step 400, water channels in the form of aquaporin water channels 410 are mixed with detergent in the form of doceyl-β-d-maltoside 402. The aquaporin water channels 410 mixed with doceyl-β-d-maltoside 402 are then added to an empty vesicle 408 or in some cases added to a mixture of vesicle membrane forming components such as monomers, lipids or mixtures thereof. The mixture is then incubated and the aquaporins 410 are subsequently integrated in the membrane of the vesicles to form a transmembrane aquaporin incorporated vesicle 414. The doceyl-β-d-maltoside 402 can then be removed 412 by using biobeads or dialysis (not shown).

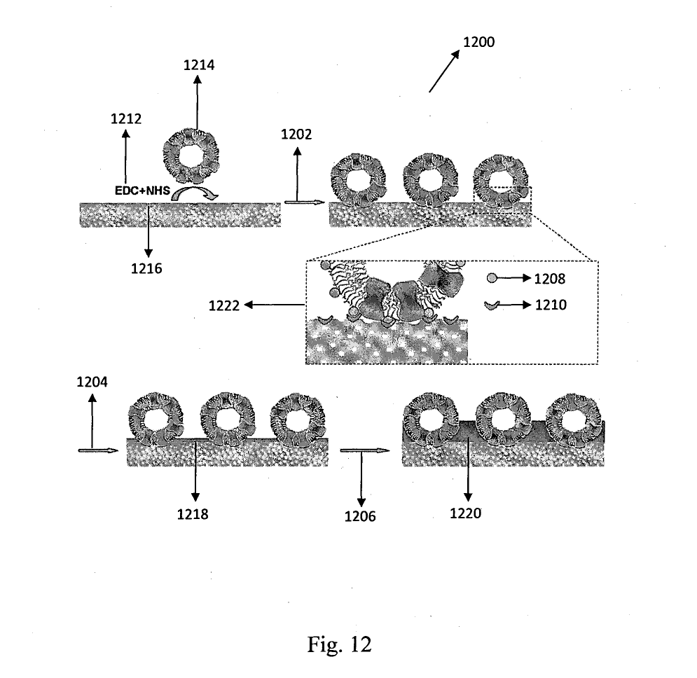

Turning to FIG. 12, there is shown of a method 1200 of making a membrane in accordance with one embodiment disclosed herein. In the first step 1202, AQPz-incorporated vesicles 1214 are immobilized onto a functional porous membrane substrate 1216 in the presence of a catalyst in the form of a mixture of 1-Ethyl-3-[3-dimethylaminopropyl]carbodiimide hydrochloride and N-hydroxysulfosuccinimide (EDC+NHS) 1212. In the magnified schematic 1222, the functional porous membrane substrate 1216 is shown to comprise of amine functional groups 1210 which forms an amide linkage with the carboxyl acid functional groups 1208 on the AQPz-incorporated vesicles 1214. In the second step 1204, a layer of initiators, in the form of ammonium persulfate and sodium bisulfite 1218 are deposited onto the surface of the vesicle immobilized membrane. In the third step 1206, a dense polymer layer 1220 is generated by in-situ polymerization of a monomer solution in the form of ethylene glycol dimethacrylate deposited over the porous membrane substrate 1216, forming the AQPz-vesicular incorporated membrane.

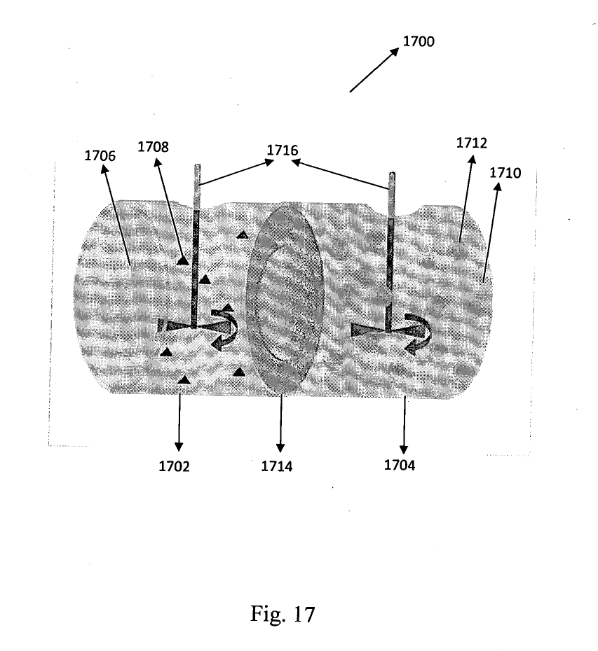

Referring to FIG. 17, a schematic representation of a forward osmosis (FO) permeation cell 1700 in accordance with one embodiment disclosed herein is shown. The FO permeation cell 1700 comprises two chambers, the feed solution chamber 1702 and the draw solution chamber 1704. A filter membrane in the form of an Aquaporin z (AQPz) incorporated vesicular membrane 1714 is disposed in the middle of the FO permeation cell 1700, separating the feed solution chamber 1702 and the draw solution chamber 1704. The feed solution chamber 1702 comprises a feed solution 1706 with dissolved NaCl 1708. The draw solution chamber 1704 comprises a draw solution 1710 with dissolved sucrose 1712. Stirrers 1716 are used to stir the solution in the respective chambers.

In operation, the AQPz-incorporated vesicular membrane 1714 is used to effect the separation of water from the dissolved NaCl 1708 in the feed solution 1706. The concentration of the draw solution 1710 has low water concentration relative to that of the feed solution 1706, thus creating an osmotic pressure gradient to induce a net flow of water from the feed solution 1706 through the APQz-incorporated vesicular membrane 1714 into the draw solution 1710. The APQz-incorporated vesicular membrane 1714 is selectively or semi permeable and does not allow the dissolved NaCl or sucrose from passing through. This effectively separates the water in the feed solution 1706 from its dissolved NaCl 1708.

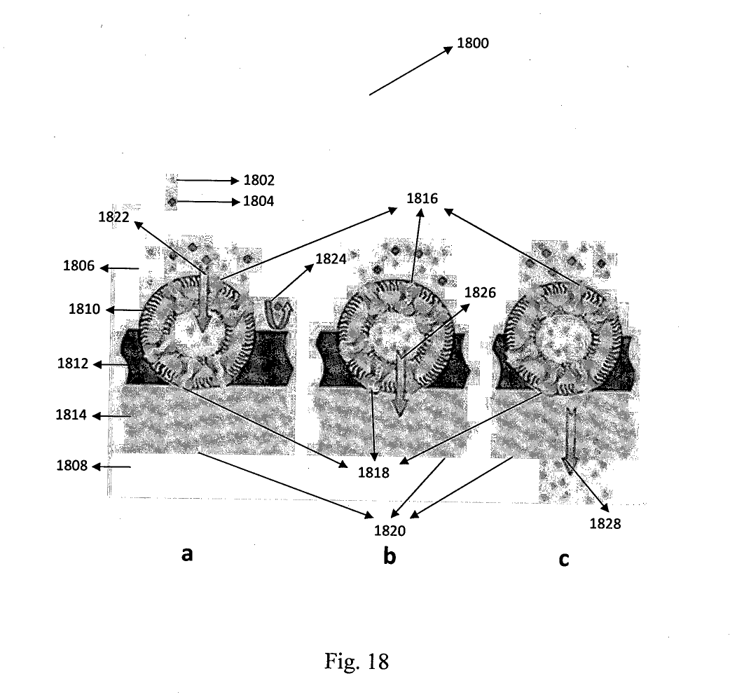

Referring now to FIG. 18, there is shown a schematic representation 1800 that illustrates the water purification mechanism for an AQPz-vesicle imprinted membrane 1820 in accordance with one embodiment disclosed herein. An AQPz vesicle 1810 is shown to be immobilized on the porous membrane substrate 1814 and partially covered by an imprinted polymer layer 1812. FIGS. 1800a to 1800c show the same AQPz-vesicle imprinted membrane 1820 in operation as water molecules 1802 in the feed solution 1806 pass through the AQPz-vesicle imprinted membrane 1820 through a 3 step process.

In the first step 1822, water molecules 1802 from the feed solution enter the AQPz vesicle 1810 via the AQPz water channel 1816 located on the side facing the feed solution 1806. Solutes 1804 in the feed solution 1806 are unable to pass through the AQPz water channel 1816 and are also rejected by the water impermeable polymer layer 1812 surrounding the vesicles as shown in the arrow 1824. In the second step 1826, water molecules 1802 passes from the AQPz vesicle 1810 to the porous membrane substrate 1814 through the AQPz water channel 1818 located on the side facing the substrate membrane 1814. In the third step 1828, water molecules 1802 passing through the porous membrane substrate 1814 into the permeate solution 1808.

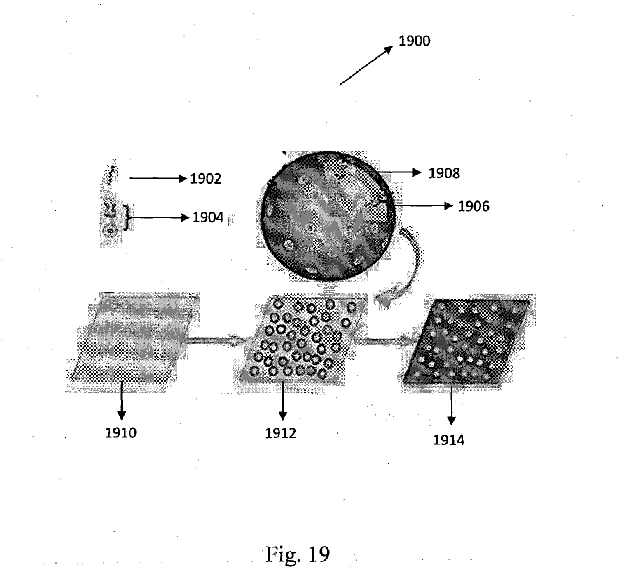

Referring to FIG. 19, there is shown a membrane in different stages of preparation in accordance with one embodiment disclosed herein. An AQPz-incorporated vesicle 1906 comprising a polymersome 1908 with a plurality of Aquaporin 1904 incorporated therein is used to prepare the membrane. A plurality of AQPz-incorporated vesicle having the similar structures as that of the AQPz-incorporated vesicle 1906 are immobilized onto a porous membrane substrate 1910, resulting in a modified porous membrane substrate 1912 having numerous AQPz-incorporated vesicles immobilized thereon. A layer of polymer is then generated on the porous membrane substrate to partially cover the AQPz-incorporated vesicles which are immobilized on the porous membrane substrate to form the final membrane 1914.

### EXAMPLES

Example embodiments of the disclosure will be better understood and readily apparent to one of ordinary skill in the art from the following examples, and if applicable, in conjunction with the figures.

### Example 1

### Polymer Synthesis and Characterization

The vesicles in accordance with one embodiment disclosed herein were formed from a ABA triblock copolymer mixture of poly(2-methyloxazoline)-block-poly(dimethylsiloxane)-block-poly(2-methyloxazoline) (PMOXA-PDMS-PMOXA) with carboxyl acid functional end groups (P1) and poly(2-methyloxazoline)-block-poly(dimethylsiloxane)-block-poly(2-methyloxazoline) with methacrylate functional end groups (P2). ABA copolymers with functional groups were prepared by end group modification.

Preparation of block copolymer P1:

Hydroxyl-terminated PMOXA-PDMS-PMOXA (Mw: 1300-5000-1300, Polymer Source) (1 g, 1.316×10⁻⁴ mol) was dissolved in 20 ml of chloroform at room temperature in a round-bottomed flask with a reflux condenser under argon. A five-fold excess amount of succinate anhydride (0.158 g, 1.58×10⁻³ mol) (Sigma Aldrich) was added to the polymer solution, followed by a catalytic amount of 4-dimethylaminopyridine (DMAP, Sigma Aldrich). The solution was left at room temperature with stirring for 48 h. The solvent was removed through evaporation under a strong vacuum. The raw product was purified through dialysis with water, followed by freeze-drying to obtain a solid product.

Preparation of functionalized block copolymer P2:

Hydroxyl-terminated PMOXA-PDMS-PMOXA (1 g, 1.316×10 mol) (Mw: 1300-5000-1300, Polymer Source) was dissolved in dry ethyl acetate (10 ml, Sigma Aldrich) at room temperature in a round-bottomed flask with a reflux condenser under argon. Dibutyltin dilaurate (35 mg, Sigma Aldrich) and 2-isocyanatoethylmethacrylate (IEM, Sigma, Aldrich) (42 mg, 2.819×10 mol, 3.5% excess) were added to the polymer solution. The mixture solution was left at 40° C. with periodic stirring for 48 h in the absence of light. The solvent was removed through evaporation under a strong vacuum. The raw product was purified through ultrafiltration in a water-ethanol mixture (1:2, w:w) to remove impurities with a low molecular weight.

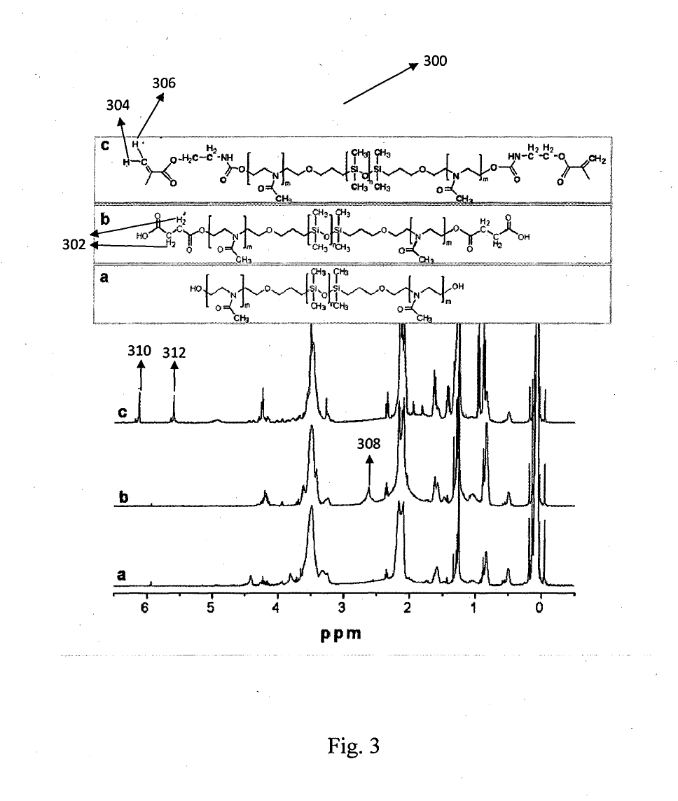

As shown in FIG. 3, the structures of P1 and P2 are confirmed by ¹H NMR (500 MHz, CDCl₃, δ). FIG. 3a shows the chemical structure and spectrum of the block polymer of hydroxyl-terminated PMOXA-PDMS-PMOXA before functionalization with methacrylate or carboxylic acid functional groups. FIG. 3b shows the chemical structure and spectrum of P₁ block polymer with carboxyl acid functional end groups, with the hydrogen atoms 302 corresponding to the peak 308. FIG. 3c shows the chemical structure and spectrum of P₂ block polymer with methacrylate functional end groups, with the protons 304 and 306 corresponding to the peaks 310 and 312 respectively.

### Example 2

### Expression and purification of Aquaporin Z (AQPz)

E. coli genomic DNA was extracted and subsequently used to clone the AQPz gene. Primers were designed based on the published AQPz nucleotide sequence (Genebank Accession number: U38664). The AQPz gene was amplified and cloned into the pCR-4 vector using the TOPO cloning kit (Invitrogen, USA). The positive clones were sequenced and further subcloned into a modified expression vector, the pQE-30 Xa expression vector, with ampicillin selection and an amino-terminal 10× His affinity tag (Qiagen, USA). The E. coli strain TOP10F was transformed and grown to 0.6-1 optical density (OD) at 600 nm in Lysogeny broth (LB) with 100 mg/l of ampicillin and subsequently induced with 1 mM of isopropyl-D-thiogalactoside. The harvested cells were resuspended in one 1/50 culture volume of ice-cold lysis buffer containing 100 mM of K₂HPO₄, 1 mM of MgSO4, 1 mM of phenylmethylsulfonylfluoride (PMSF), and 0.1 mg/ml of deoxyribonuclease I (pH 7.0). Cells were subjected to 4 lysis cycles in a French press (115×10⁶ Pa at 4° C.). The unbroken cells and debris were separated from the cell lysate by a 45 min centrifugation at 10,000 g and discarded. Membrane fractions were recovered from the supernatant by a 60 min centrifugation at 100,000 g. AQPz was solubilized from pellets by agitation in 1% dodecyl maltoside and PBS. The solubilized protein was purified through Ni-NTA resin (Qiagen, USA), washed, and eluted with PBS (pH 7.4) and 250 mM of imidazole. The imidazole was removed using a Bio-Rad (Hercules, Calif., United States) Econo-Pac DG10 desalting column. The resulting recombinant Aquaporin Z protein contained the 10 His tag at the protein's N-terminus and was utilized for embedding into membranes and vesicles.

### Example 3

### Preparation of Protein Incorporated Vesicles and Characterization

AQPz proteins were inserted into vesicles and the water permeability was measured. The vesicles used in these experiments were formed from block copolymers mixtures of PMOXA-PDMS-PMOXA with methacrylate functional groups and PMOXA-PDMS-PMOXA with carboxyl acid functional groups (Mw: 1300-500-1300, Polymer Source).

In this example, the block copolymer PMOXA-PDMS-PMOXA is used for the formation of the vesicles. However, it will be appreciated that the materials used to form the vesicles should not be limited to this particular PMOXA-PDMS-PMOXA. Other types of amphiphilic block copolymers and lipids with phase transition temperatures lower than 37° C. and that may have the potential to incorporate AQPz can also be used.

Vesicles were formed through the film rehydration method. P2 (5 mg, 8.3×10⁻⁴ mmol) and P1 (0.15 mg, 1.7×10⁻⁴ mmol) were both dissolved in 3 ml of chloroform. The chloroform was evaporated slowly by a rotary evaporator to form an even film on the round-bottomed flask. This film was further dried under a strong vacuum overnight. Then, the dry film of PMOXA-PDMS-PMOXA was rehydrated with 1× phosphate buffered saline (PBS, Sigma-Aldrich) and the mixture was then left at room temperature under stirring for about 8-10 hours. The resultant vesicles suspension was then extruded 21 times using a polycarbonate membrane to achieve a narrow size distribution.

For preparation of aquaporin incorporated vesicles, the procedure was similar to that above with the additional step of adding an appropriate amount of AQPz solution (for example: 1 mg/ml in 9 mM dodecyl-β-d-maltoside, DDM) during formation of vesicles. Then, the detergent can be removed by using biobeads or dialysis. An exemplary schematic illustration of the step of incorporating aquaporin into the vesicles is shown in FIG. 4.

To achieve unilamellar nano-sized vesicles with a narrow size distribution, proteopolymersomes were further extruded through a polycarbonate filter with a pore size of 100 nm for 21 times.

The extruded vesicle solution was purged with argon for 10 min and further crosslinked under UV irradiation (254 nm, 6 mW/cm²) for 15 min using a BLX-E254 crosslinker (Vilber Lourtmat, France). The polymer vesicles before and after UV irradiation were freeze-dried and characterized by a Fourier transform infrared spectrometer (FTIR-8400 Shimadzu Corp., Japan) to determine the crosslinking reaction between the methacrylate groups.

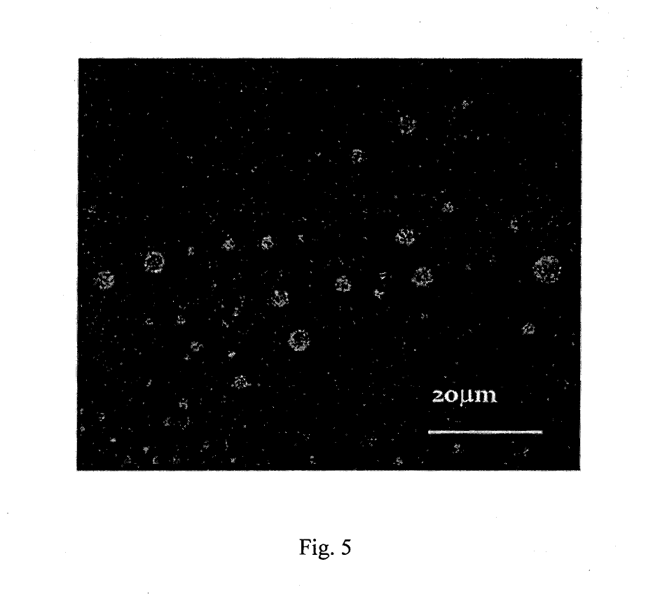

Morphology of non-extruded vesicles was measured by a confocal laser scanning microscope (Nikon, A1R, Tokyo, Japan). The excitation wavelength used was 495 nm and the emitted fluorescence was detected at a wavelength of 520 nm. For evaluation of the images, the EZ-C1 3.60 software (Nikon, Tokyo, USA) was used. The self-assembled polymerosomes were incubated with a hydrophobic green fluorescence dye Coumarin-6 (Sigma Aldrich) for 24 h before observation. Vesicle size was measured by a dynamic light scattering unit (Zetasizer 3000 HAS equipped with a He—Ne laser beam at 658 nm, Malvern Instrument Ltd., Malvern, UK; scattering angle: 90°). An average value was obtained from three measurements. Table 1 below shows that the average diameters of the extruded vesicles have been regulated by the pore size of the polycarbonate membrane used for the extrusion while the vesicle sizes remained the same before and after UV-crosslinking. The non-extruded proteopolymersomes appeared as hollow spheres under confocal microscopy as shown in FIG. 5, confirming the formation of polymer vesicles.

TABLE 1
Diameter of vesicles by DLS. Values represent the mean ±
standard deviation (error bars) with n = 3.

| Pore size of filter | Average diameter of | Average diameter of |
|---|---|---|
| membrane | uncrosslinked | crosslinked |
| (nm in diameter) | vesicles (nm) | vesicles (nm) |
| 100 | 132 ± 3 | 128 ± 3 |
| 200 | 264 ± 5 | 260 ± 6 |

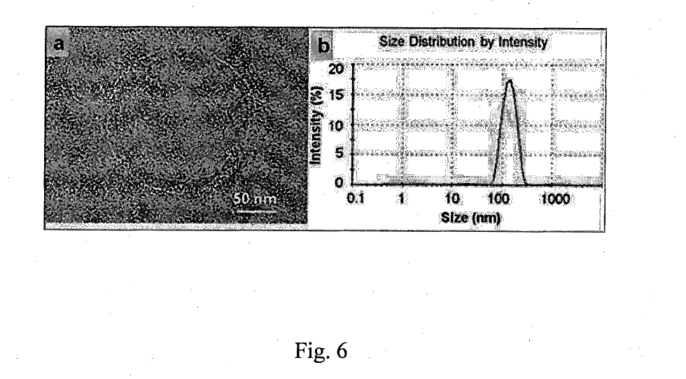

The morphologies and size distribution of the extruded proteopolymersomes were characterized by field emission transmission electron microscopy (FETEM) and dynamic light scattering (DLS), as shown in FIG. 6, where they exhibited a small, hollow, spherical unilamellar structure with an average diameter of approximately 130 nm and a narrow size distribution (polydispersity index (PDI): 0.07-0.09). The UV-crosslinked vesicles showed a morphology and dimension similar to those of the uncrosslinked vesicles according to Transmission Electron Microscopy (TEM) and Dynamic Light Scattering (DLS) (results not shown), indicating that the UV-crosslinking of the methacrylate groups on the ABA polymer end groups did not change the structure or dimensions of the polymer vesicles.

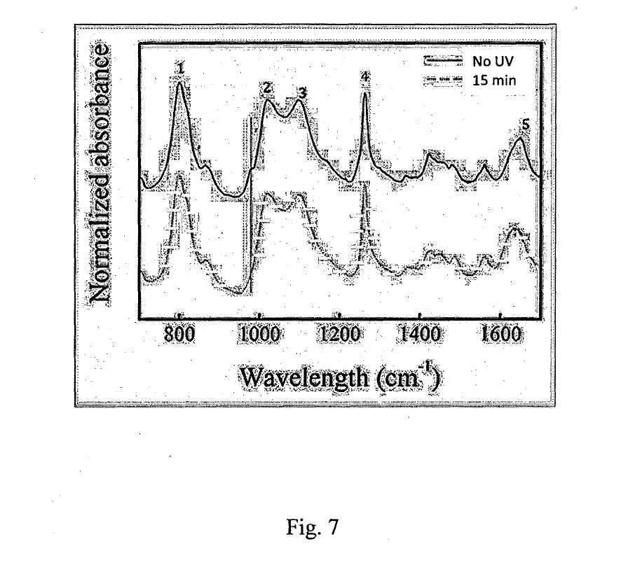

The polymer vesicles before and after UV irradiation were freeze-dried and characterized using a Fourier transform infrared (FTIR) spectrometer to determine the crosslinking reaction between the methacrylate groups. The PDMS and PMOXA parts are shown as distinct peaks 1-5 in FIG. 7. The peak at 799 cm⁻¹ represents the Si—CH₃ bond stretching and CH₃ rocking vibrations. The double peaks at 1020 cm⁻¹ and 1097 cm⁻¹ represent Si—O—Si bond stretching vibrations. The peak at 1262 cm⁻¹ represents the CH₃ symmetric deformation in the Si—CH₃ bonds. The peak at 1632 cm⁻¹ represents the amide C═O bond from the PMOXA.

The peak at 980 cm⁻¹ represents the trans CH wag in the methacrylate functional end group C(O)—CH═CH₂. The exposure of vesicles to UV light resulted in the disappearance of this peak, indicating that the double bonds in the methacrylate groups were successfully crosslinked by UV irradiation.

### Example 4

### Measurement of Vesicle Permeability

The permeability of two kinds of vesicles (polymersome and proteopolymersome) was determined using the stop-flow method. All vesicles used for the stopped-flow characterization were pre-extruded to ensure a unilamellar structure and narrow size distribution with a diameter of approximately 130 nm and a PDI of less than 0.1. Vesicles were rapidly mixed with a hyperosmolar sucrose buffer causing water efflux from vesicle and consequently resulting in vesicle shrinkage. The vesicle size changes were detected by light scattering and recorded at an emission wavelength of 577 nm in the stop-flow apparatus. The measuring temperature was 25° C. A signal increase, which was caused by vesicle size reduction, was fitted to an exponential rise equation as follows:

Y=Aexp(−kt) (1)

where Y is the intensity of signal, t is the recording time, in s, A is a constant, k is the initial rate constant, in s⁻¹. The osmotic water permeability was calculated from Equation (2).

$${P}_{f} = \frac{k}{( S / {V}_{0} ) {V}_{w} {Δ}_{osm}} \qquad ( 2 )$$

where S is the vesicle surface area, in m², V₀ is the initial volume of vesicles, in m³, V_{w} is the partial molar volume of water (0.018 L/mol), Δₒₛₘ is the osmolarity difference that drives the shrinkage of vesicles, in osmol/L, and P_{f} is the osmotic water permeability, in m/s.

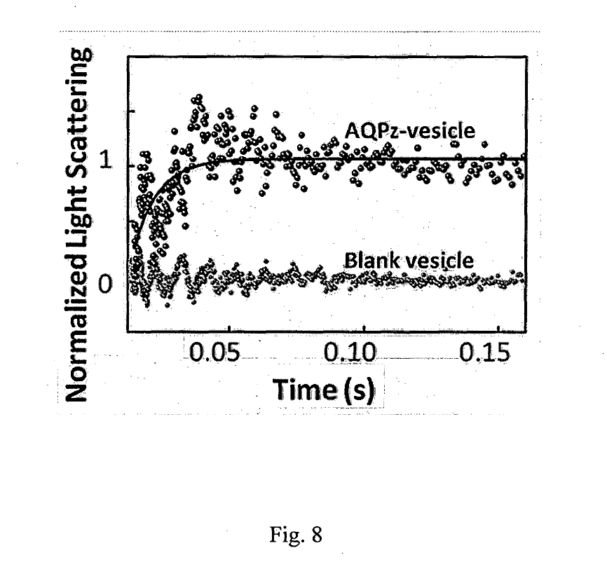

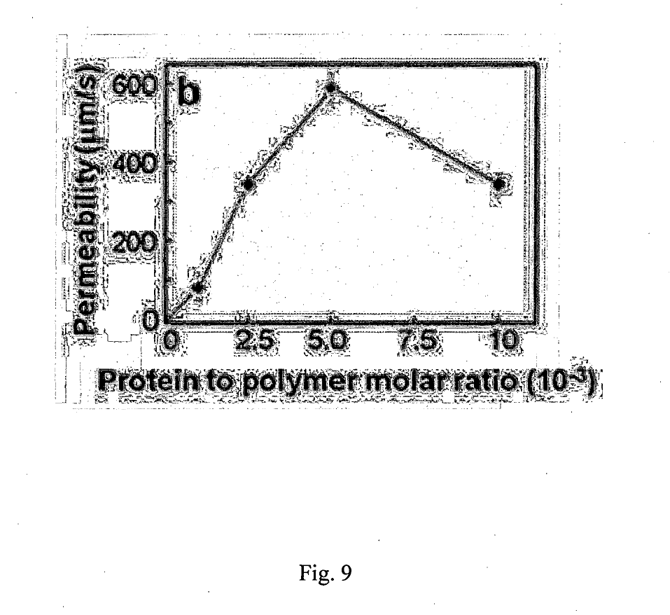

Polymersomes and proteopolymersomes were rapidly mixed with a 600 mosmol/l sucrose solution. FIG. 8 shows an example of increase in relative light scattering signals with (AQPz: polymer=1:200, molar ratio) and without AQPz into the crosslinked PMOXA-PDMS-PMOXA membrane at 25° C. The polymer vesicles without AQPz did not respond to osmotic pressure; thus, the vesicle permeability was too low to be calculated. The low permeability of the polymer vesicles indicates that the hydrophobic layer of the vesicles was sufficiently thick to work as a barrier to prevent water diffusion through the vesicle membrane. The permeability of the AQPz-vesicles was calculated to be 585 μm/s. The incorporation of AQPz led to a significant increase in permeability compared to the blank polymer vesicles, indicating that AQPz reconstitution into the PMOXA-PDMS-PMOXA vesicles occurred in the correct configuration. The permeability of the single AQPz channel was calculated to be 12×10⁻¹⁴ cm³ s⁻¹ subunit⁻¹. AQPz was incorporated into block copolymers at different protein polymer ratios, and the water permeability reached a maximum at a protein-polymer molar ratio of 1:200, as shown in FIG. 9.

### Example 5

### Effects of UV-Crosslinking on Vesicle Permeability and AQPz Functionality

To study the effects of UV-crosslinking on vesicle permeability and AQPz functionality, three control groups were used, based on the permeability results of the stopped-flow apparatus.

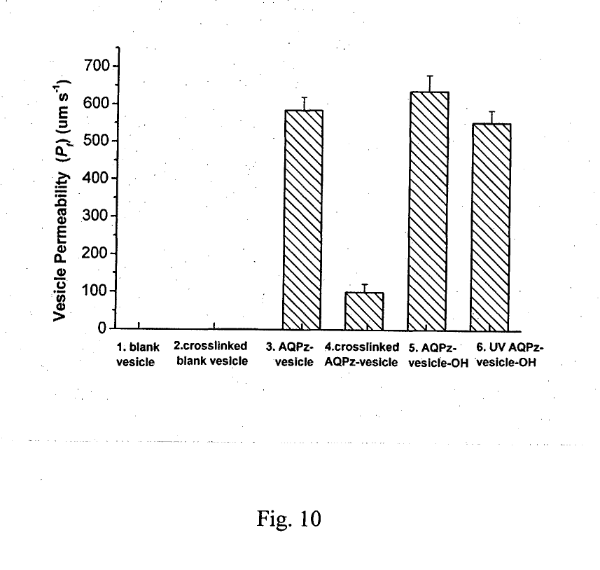

The first group was comprised of blank vesicles without AQPz before and after UV-crosslinking. The UV-crosslinked polymer vesicles without AQPz did not respond to the osmotic pressure, which was a similar behaviour as that of the un-crosslinked vesicles without AQPz, as shown in FIG. 10. Together with the TEM and DLS characterization, it can be concluded that UV-crosslinking of the methacrylate groups located in the hydrophilic layer did not affect the thickness or density of the hydrophobic PDMS layer and thus did not lead to water leakage through the vesicle membrane.

The second group was comprised of AQPz vesicles before and after UV-crosslinking. After UV-crosslinking, the AQPz-vesicles had a decreased apparent permeability compared to that before crosslinking as shown in FIG. 10 (bars representing 2 and 3), indicating that the UV-crosslinked AQPz-polymer vesicles shrunk more slowly than those before UV-crosslinking under the same osmotic pressure. Without intending to be bound by theory, it is believed that are two possible reasons for this phenomenon. First, some of the incorporated AQPz may have lost functionality after the crosslinking step when exposed to UV radiation. Second, a covalent polymer network, generated due to the crosslinking, may have covered the entire vesicle, including the inner and outer surfaces. Because the shape and size of the crosslinked vesicles were fixed to a certain extent by the covalent network, the covalent polymer network resisted rapid shrinking when subjected to osmotic pressure, resulting in light scattering results that are merely indicative of little or no change in vesicle size and may not accurately represent the vesicle permeability per se. Thus, to identify the exact reason, a third control group of AQPz vesicles without crosslinking functional groups before and after UV irradiation was used.

The permeability of AQPz-incorporated hydroxyl-terminated PMOXA-PDMS-PMOXA vesicles (AQPz: polymer=1:200 molar ratio), which were exposed to UV irradiation (254 nm) for 15 min without resulting in polymer crosslinking, was found to be similar to that before UV irradiation as shown in FIG. 10 (bars 4 and 5) suggesting that the AQPz incorporated into the PMOXA-PDMS-PMOXA membrane was sufficiently stable to maintain its functionality even upon exposure to UV light. Therefore, it appears that UV-crosslinking provided mechanical strength to the AQPz-polymer vesicles while maintaining the water transport functionality of the incorporated aquaporin.

### Example 6

### Preparation and Modification of Porous Substrate

In this example, the porous substrate membrane used was cellulose acetate (CA) membrane with an average pore size of approximately 25 nm. Raw CA-389-30 powder from Eastman Chemical Company, USA was dried overnight at 120° C. under vacuum. A CA solution was prepared by dissolving the dried CA (15 wt %) in N-Methyl-2-pyrrolidone (85 wt %) under constant mechanical stirring (100 rpm) in a flask for 14 h and 40° C. The obtained homogeneous solution was allowed to stand at room temperature for a day to remove bubbles. The polymer solution was poured onto a glass plate at ambient temperature and casted with a casting knife to obtain a designed thickness of 250 μm. The glass plate was then immediately immersed in a water bath at ambient temperature for precipitation and solvent exchange for 48 h.

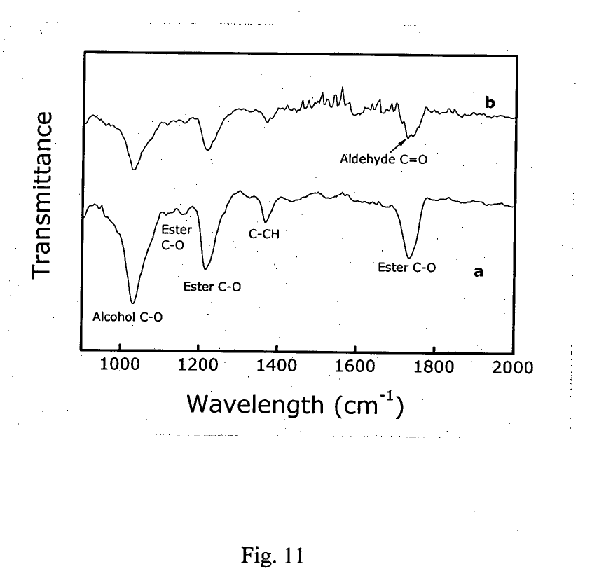

Surface Aldehyde functionalization was carried out on the CA membrane prepared above. The CA membrane with an apparent surface area of 20 cm² was fixed onto a Petri dish to ensure that oxidation by 15 ml of sodium periodate solution occur mainly on the top of the membrane surface. Periodate solutions with the concentrations of 7.0 wt % were used to produce different density of dialdehyde groups on the membrane surface. The oxidization was conducted for 6 h at room temperature in the dark. As shown in the Fourier Transform Infra Red (FTIR) spectrum of FIG. 11, the appearance of the characteristic peak of aldehyde group at ˜1720 cm⁻¹ demonstrates that the modification of CA membrane using NalO₄ generated aldehyde groups from the hydroxyl groups of the CA polymer. Line (a) of FIG. 11 shows the cellulose acetate substrate before aldehyde functionalization and line (b) shows the cellulose acetate substrate after aldehyde functionalization.

CA membrane with aldehyde groups on the surface was further modified with amine groups. Briefly, the surface aldehyde-functionalized CA membrane was incubated with a 0.5 wt % ethylene diamine solution for 1-15 h to generate amine groups on the membrane surface. The reaction was stopped by flushing the membrane surface with large amount of de-ionized water. From X-ray photoelectron spectroscopy (XPS) results, the appearance of the nitrogen element demonstrated that the amine groups were successfully generated on the membrane surface. These amine groups could then be further used for subsequent covalent vesicles immobilization.

While the substrate used in this example is cellulose acetate membrane, it will be appreciated that other types of substrate (for example, polycarbonate, polyamine, polysulfone and polyethylene terephthalate) having a porous structure and which possesses the potential to be functionalized with primary amine residues, may be used as the support membrane.

### Example 7

### Immobilization of Protein Incorporated Vesicles onto Porous Substrate

Aquaporin incorporated PMOXA-PDMS-PMOXA vesicles prepared with carboxyl acid functional groups were conjugated on the modified CA membrane surface through the reaction between carboxyl acid groups and amine groups. Briefly, the amine functionalized membrane was mounted onto the bottom of the container and incubated with a polymer vesicles solution (0.5-10 mg/ml, preferably 4 mg/ml, 2 ml/cm²) for 24 h under the catalyst of 1-Ethyl-3-[3-dimethylaminopropyl]carbodiimide hydrochloride (EDC, Sigma Aldrich) and N-hydroxysulfosuccinimide (NHS, Sigma-Aldrich). The vesicle-immobilized membranes were then washed thoroughly with de-ionized water.

In this example, the vesicles were immobilized on the membrane through reaction between carboxyl acid groups and amine groups. However, it will be appreciated that immobilization reaction disclosed herein may be carried out through the reaction between other functional group and should not be limited to these two particular functional groups. A conjugation reaction possessing the potential to covalently bind vesicles to the membrane may be adopted.

### Example 8

### Formation of Polymer Dense Layer on the Porous Membrane Surface

After the protein incorporated vesicles were immobilized on the porous membrane surface, free radical initiators were then deposited on the top surface of the substrate and in-situ polymerization was carried out to form a dense polymer layer on the top surface of the porous substrate. Briefly, methyl methacrylate (5 ml, MMA, Sigma-Aldrich) and ethylene glycol dimethacrylate (20 ml, EGDMA, Sigma-Aldrich) were mixed at 40° C. under nitrogen. The initiators ammonium persulfate (APS, Sigma Aldrich) and sodium bisulfite (25 mg/ml, SBS, Sigma-Aldrich) solutions were prepared separately and filtered through a poly(ether sulfone) filter with the pore size of 0.45 μm. The initiators were then coated onto the surface of the vesicles immobilized membrane using a spin-coater (Laurel, Miss., USA). The membrane was immediately dipped into the ethylene glycol dimethacrylate (EGDMA) monomer solution for free radical polymerization at 40° C. The duration of polymerization was adjusted to control the thickness of the polymer layer. Upon completion, the membrane was washed twice with 10% sodium dodecyl sulfate (SDS, Sigma-Aldrich) solution to remove any remaining monomers and several times with de-ionized water to remove the remaining SDS. The preparation procedure is illustrated in FIG. 12.

A “non-vesicle-imprinted” membrane (NVIM) was prepared as a control. Preparation of the NVIM followed that of the “vesicle-imprinted” membrane (VIMs) described above, except that a blank porous CA support membrane was used instead of the vesicle-immobilized membrane.

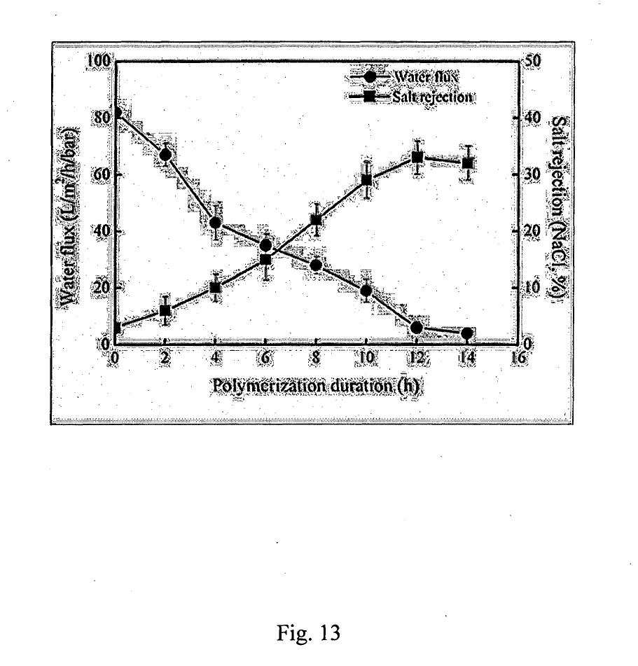

The duration of the polymerization reaction was used to control the thickness of the imprinted polymer layer, which is believed to play an important role in membrane performance. Specifically, if the polymerization time is too short, then the imprinted polymer layer may not be sufficiently thick to cover all of the pores on the substrate surface, resulting in membrane leakage. To find the most appropriate polymerization duration and thickness for the imprinted layer, a series of imprinting polymerization were carried out on the non-vesicle immobilized porous CA membrane with different polymerization period. The membranes nanofiltration performances were tested to determine an optimized polymerization period for the imprinting polymerization. The nanofiltration was characterized via salt rejection by using an argon-pressurized dead-end stirred permeation cell. As shown in FIG. 13, when the polymerization time was less than 12 hours, the water flux decreased and the salt rejection increased with increasing polymerization time, indicating a denser and thicker imprinted layer with a longer polymerization period. However, as the polymerization time increased beyond 12 hours, the salt rejection remained constant, and the water flux decreased. Thus, polymerization duration of 12 hours was chosen for the imprinting polymerization in this example.

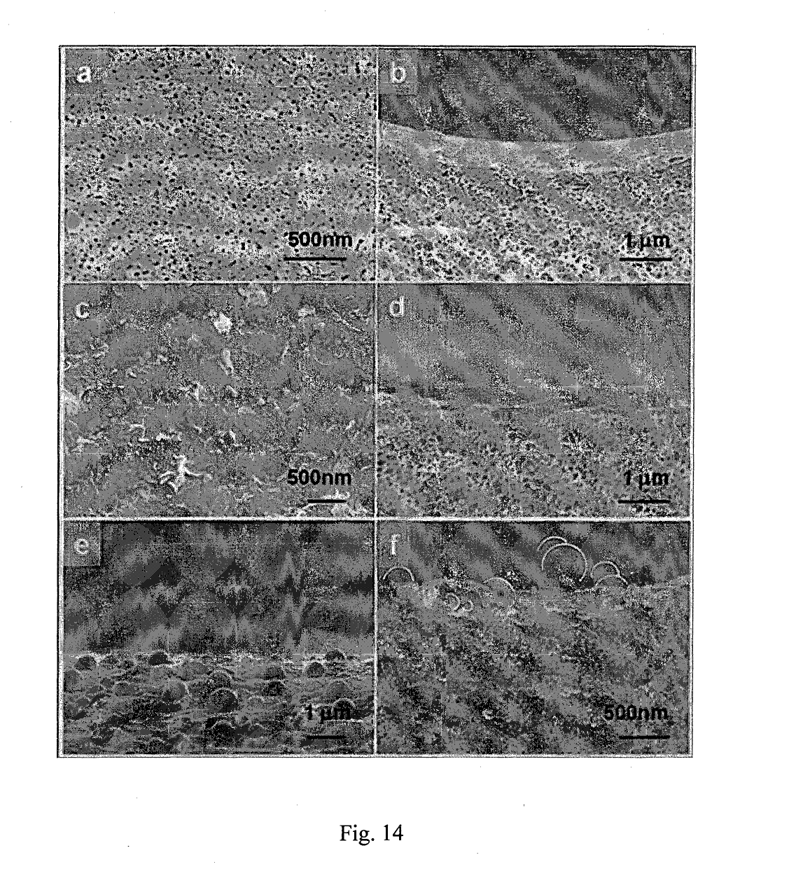

FIG. 14 shows the morphologies of the top surfaces and cross sections of the original substrate CA membrane, non-vesicle-imprinted membrane and AQPz-vesicle-imprinted membrane using a field emission scanning electron microscope. Compared to the morphology of the original substrate membrane (FIG. 14a and FIG. 14b), the pores on the substrate surface were completely covered by the dense polymer layer after surface imprinting polymerization, and the average thickness of the dense polymer layer was about 170 nm (FIG. 14c and FIG. 14d). To avoid being completely covered and entrapped by the imprinted layer, the dimensions of the immobilized vesicles must be adjusted so that they are larger than the thickness of the imprinted layer to prevent water channel blockage. Therefore, the average diameter of vesicles was chosen to be 260 nm in this example, which is larger than the thickness of the dense layer in this example. FIG. 14e and FIG. 14f show that the vesicles were half embedded and tightly surrounded by the dense polymer layer and that all of the gaps between the vesicles were filled with the dense layer. Thus, the AQPz-vesicle-imprinted membrane was successfully fabricated.

In this example, APS and SBS were used as initiators and EGDMA were used as monomer. However, it will be appreciated that other initiators or monomers may be used. Other free radical initiators and other monomers having the potential to form the dense polymer layer may also be used.

### Example 9

### Nanofiltration, 2 Stages Nanofiltration

The membrane nanofiltration performance was characterized via salt rejection by using an argon-pressurized dead-end stirred permeation cell. The experiment was carried out under a hydraulic pressure of 5 bar and under a stirring speed of 600 rpm. The pure water permeability (L) was calculated by weighing the collected permeate. Sodium chloride and magnesium chloride were used as solutes for the preparation of the feed solutions at concentrations of 200 ppm. The concentrations of the feed and permeate solutions were determined using a conductivity meter (F-50, HORIBA). The salt rejection was calculated as in Equation (3).

S=C_{f}−Cₚ/C_{f}×100% (3)

Where C_{f} and Cₚ (ppm) are the salt concentrations in the feed and permeate solutions, respectively.

After that, the second stage nanofiltration was conducted to the AQPz-vesicle-imprinted membrane by using an argon-pressurized dead-end stirred permeation cell, under a hydraulic pressure of 5 bars and a stirring speed of 600 rpm. The permeate solution concentration after the first stage nanofiltration with the AQPz-vesicle-imprinted membrane was employed as the feed solution concentration for the second stage nanofiltration. The pure water permeability and the salt rejection for the second stage nanofiltration were calculated using the same method in the first stage. The overall water permeability for 2 stages nanofiltration was determined by the lower permeability between these 2 stages. The overall salt rejection for the 2 stages nanofiltration was calculated as in Equation (4).

Rₒᵥₑᵣₐₗₗ=[1−(1−R₁)×(1−R₂)]×100% (4)

Where Rₒᵥₑᵣₐₗₗ is the overall salt rejection for 2 stages nanofiltration, R₁ is the salt rejection for the first stage nanofiltration, and R₂ is the salt rejection for the second stage nanofiltration.

All of the tests were conducted in triplicate. Morphology of AQPz-vesicle-imprinted membrane after nanofiltration was observed by scanning electron microscopy. After nanofiltration test, the AQPz-vesicle-imprinted membrane was washed with large amount of deionized water to remove salt residues on membrane surface, followed by freeze-drying. Morphological observation of the membranes was conducted using a field emission scanning electron microscopy (FESEM) (JSM-6700F, JEOL). The freeze dried membrane was then mounted onto sample holder using conductive carbon adhesive tape. The samples were sputtered with platinum to a thickness of 2×10⁻⁸ m before FESEM observation.

The nanofiltration performance of different membranes including those prepared by methods disclosed herein is shown in Table 2. The hydrophilic CA substrate membrane does not reject NaCl or MgCl₂, indicating that the dense polymer layer embedded with AQPz vesicles served as the selective layer. Furthermore, the water flux of the AQPz-vesicle-imprinted membrane was 61% higher than that of the vesicular membrane without AQPz. The AQPz-vesicle-imprinted membrane's salt rejections for both NaCl and MgCl₂ were much higher than those of the vesicular membrane without AQPz. These results indicate that the increased water flux and salt rejection were due to the water channel protein AQPz, proving that AQPz retained its water selectivity and transport functionality in the AQPz-vesicle-imprinted membrane under a high hydraulic pressure (5 bars) and shear force generated by stirring during nanofiltration.

Moreover, the permeate solution after nanofiltration of the AQPz-vesicle-imprinted membrane was further employed as the feed solution for a second stage nanofiltration with AQPz-vesicle-imprinted membrane under pressure of 5 bars. From Table 2, it can be seen that after 2 stages nanofiltration, the overall water permeability is 22.9 L m⁻² h⁻¹ bar⁻¹, and the overall salt rejections reach 61% and 75% for NaCl and MgCl₂ respectively. These results indicate that both high water permeability and high salt rejection could be achieved simply by two stages nanofiltration upon using the AQPz-vesicle-imprinted membrane prepared by the methods disclosed herein.

TABLE 2
Nanofiltration performance of the membranes. Values represent the
mean ± standard deviation (error bars) with n = 3

| | Pure water | NaCl | MgCl₂ |
|---|---|---|---|
| | Permeability | Rejection | Rejection |
| Membrane | (L m⁻² h⁻¹ bar⁻¹) | (%) | (%) |
| CA^{a} | 81.9 ± 3.2 | 0 | 0 |
| NVIM^{b} | 6.1 ± 2.2 | 33 ± 2 | 36 ± 1 |
| VIM^{c} | 14.3 ± 2.6 | 28 ± 2 | 32 ± 3 |
| AQPz-VIM^{d} | 22.9 ± 3.3 | 39 ± 4 | 51 ± 7 |
| AQPz-VIM 2^{nd} stage^{e} | 23.3 ± 2.5 | 36 ± 5 | 49 ± 7 |
| AQPz-VIM for 2 stages^{f} | 22.9 | 61 | 75 |

^{a}Blank CA membrane.
^{b}non-vesicle-imprinted membrane.
^{c}vesicle-imprinted membrane without AQPz incorporation.
^{d}AQPz-vesicle-imprinted membrane.
^{e}the second stage nanofiltration performance for AQPz-vesicle-imprinted membrane.
^{f}the overall 2 stages nanofiltration performance for AQPz-vesicle-imprinted membrane

### Example 10

### Membrane Testing with Nanofiltration

In another comparative example, nanofiltration tests on different membranes including those prepared by the methods disclosed herein were performed in a nitrogen-pressurized dead-end stirred permeation cell. Water permeability (L) was calculated by collecting and weighing the permeate. The experiment was carried out under pressure of 5 bars. The feed solution was a MgCl₂ solution. MgCl₂ concentration in the feed and permeate was determined from electric conductance of the solutions. Salt rejection was calculated using equation (5):

$$S = \frac{{C}_{f} - {C}_{p}}{{C}_{f}} \times 100 \% \qquad ( 5 )$$

Where C_{f} is the salt concentration in the feed solution and Cₚ is the salt concentration in the permeate.

The nanofiltration performance of the membranes is listed in Table 3.

TABLE 3
Nanofiltration performance of the membranes. Values represent the
mean ± standard deviation (error bars) with n = 3.

| | | | MgCl₂ |
|---|---|---|---|
| | Water Permeability | NaCl Rejection | Rejection |
| Membrane | [L m⁻²h ⁻¹bar⁻¹] | [%] | [%] |
| CA [a] | 81.9 ± 3.2 | 0 | 0 |
| VIM [b] | 14.3 ± 2.6 | 28 ± 2 | 32 ± 3 |
| AQPz-VIM [c] | 22.9 ± 3.3 | 39 ± 4 | 51 ± 7 |

[a] Blank CA membrane,
[b] vesicular membrane without AQPz incorporation, and
[c] AQPz-incorporated vesicular membrane.

As shown in Table 3, both the salt rejection and the water flux of the Aquaporin Z incorporated vesicular membrane are higher than vesicular membrane without Aquaporin Z incorporated, indicating that the increased water flux was caused by the incorporation of the water channel protein. It also indicates that the water channel in this protein incorporated vesicular membrane is with great stability under high pressure (5 bars). Therefore, the protein incorporated vesicular membrane disclosed herein has potential in water purification and desalination, especially nanofiltration.

### Example 11

### Second Phase Nanofiltration

After nanofiltration, a second stage nanofiltration was conducted to the AQPz-vesicle-imprinted membrane by using an argon-pressurized dead-end stirred permeation cell, under a hydraulic pressure of 5 bars and a stirring speed of 600 rpm. The permeate solution concentration after the first stage nanofiltration with the AQPz-vesicle-imprinted membrane was employed as the feed solution concentration for the second stage nanofiltration. The pure water permeability and the salt rejection for the second stage nanofiltration were calculated using the same method in the first stage. The overall water permeability for 2 stages nanofiltration was determined by the lower permeability between these 2 stages. The overall salt rejection for the 2 stages nanofiltration was calculated as in Equation (6).

Rₒᵥₑᵣₐₗₗ=[1−(1−R₁)×(1−R₂)]×100% (6)

Where Rₒᵥₑᵣₐₗₗ is the overall salt rejection for 2 stages nanofiltration, R₁ is the salt rejection for the first stage nanofiltration, and R₂ is the salt rejection for the second stage nanofiltration.

TABLE 4
Nanofiltration performance of the membranes. Values represent the
mean ± standard deviation (error bars) with n = 3

| | Pure water | NaCl | MgCl₂ |
|---|---|---|---|
| | Permeability (L | Rejection | Rejection |
| Membrane | m⁻² h⁻¹ bar⁻¹) | (%) | (%) |
| AQPz-VIM [a] | 22.9 ± 3.3 | 39 ± 4 | 51 ± 7 |
| AQPz-VIM 2^{nd} stage [b] | 23.3 ± 2.5 | 36 ± 5 | 49 ± 7 |
| AQPz-VIM for 2 stages [c] | 22.9 | 61 | 75 |

[a] AQPz—vesicle-imprinted membrane,
[b] the second stage nanofiltration performance for AQPz-vesicle-imprinted membrane, and
[c] the overall 2 stages nanofiltration performance for AQPz-vesicle-imprinted membrane.

From Table 4, it can be seen that after 2 stages nanofiltration, the overall water permeability is 22.9 L m⁻² h^{-l} bar⁻¹, and the overall salt rejections reach 61% and 75% for NaCl and MgCl₂ respectively. These results indicate that both high water permeability and high salt rejection could be achieved simply by two stages nanofiltration upon using the AQPz-vesicle-imprinted membrane in this example.

### Example 12

### Membrane Reusability

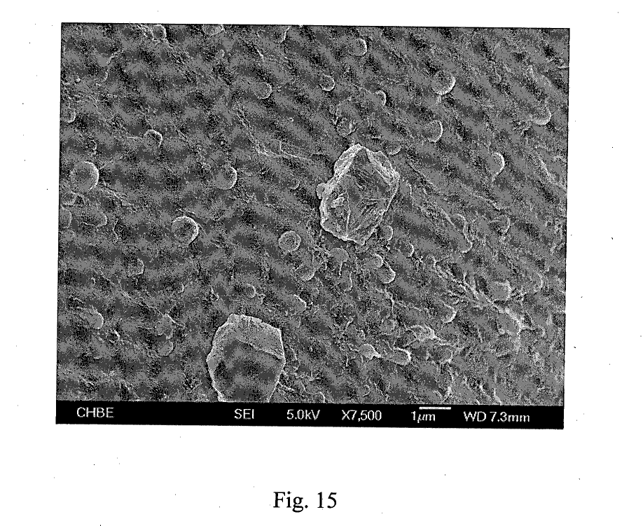

Reusability of the AQPz-incorporated vesicular membrane was tested in a nitrogen-pressurized dead-end stirred permeation cell at the same condition with the nanofiltration test. The nanofiltration period for each run was 4-6 hrs, followed by washing the membrane with large amount of ultrapure water. The same procedure was repeated for 3 times for the same membrane. Vesicles on AQPz-vesicle-imprinted membrane prepared by the methods disclosed herein remain integral sphere structure even after nanofiltration as shown in FIG. 15.

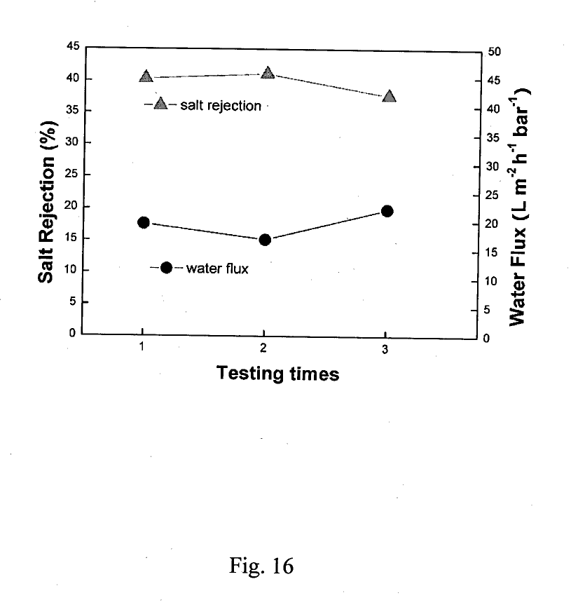

Salt rejections of NaCl and water permeabilities in each run are shown in FIG. 16. Both salt rejection and water flux remain similar for the first, second and third run, indicating that the AQP-vesicle imprinted membrane is with high mechanical strength and stability, and it could be reused in nanofiltration at least for 3 times. Two factors may contribute to this device's high resistance to hydraulic pressure. One factor may be the robustness of the polymer bilayer compared with lipid bilayers and the improvement that UV-crosslinking confers to the mechanical strength and stability of the polymer bilayer. The other factor may be the protection of the vesicles by the imprinted dense hydrophobic polymer layer, which endows the vesicles with a high resistance to increased pressure and stress.

### Example 13

### Membrane Testing with Forward Osmosis (FO)

Forward osmosis performance of an AQP-incorporated vesicular membrane prepared by the methods disclosed herein was tested with a dialysis permeation cell consisting of two chambers with a volume of 37.5 cm³ each. A representative illustration of the use of a permeation cell is shown in FIG. 17 and described above. The biomimetic membrane was clamped between the two chambers. The effective membrane area is 19.6 mm². 200 ppm NaCl solution was used as feed solution. 0.3 mol/L sucrose solution was used as draw solution. All of the tests were conducted in triplicate.

Water flux and salt flux were calculated through Equation (7) and Equation (8) respectively.

$$\begin{matrix}{J}_{w} = \frac{Δ {W}_{d}}{{D}_{w} \cdot A \cdot Δ t} & ( 7 ) \\ {J}_{s} = \frac{{C}_{f 0} \cdot {V}_{f 0} - {C}_{f 1} \cdot {V}_{f 1}}{A \cdot Δ t} & ( 8 )\end{matrix}$$

Where ΔW_{d} is the weight increase of draw solution in gram, A is the effective membrane area in m², Δt is the testing time in s, C_{f0} is a initial sodium chloride concentration of the feed solution in g/L; V_{f0} is a initial volume of the feed solution in L; C_{f1} is a final sodium chloride concentration of the feed solution in g/L; V_{f1} is a final volume of the feed solution in L.

Membrane salt rejection and selectivity was calculated as equation (9) and (10):

$$\begin{matrix}Salt\_rejection = ( 1 - \frac{\frac{saltflux}{waterflux}}{{C}_{f 0}} ) \times 100 \% & ( 9 ) \\ Selectivity = \frac{( Δ {W}_{d} - {C}_{d 1} {V}_{d 1} ) / {M}_{w}}{{C}_{d 1} {V}_{d 1} / {M}_{s}} & ( 10 )\end{matrix}$$

Where, C_{f0} is the initial salt concentration of feed solution (mol/L); C_{d1} is the final salt concentration of draw solution (mol/L); V_{d1} is the final volume of draw solution (L); ΔW_{d} is the weight increase in the draw solution (g); M_{w} is the molecular weight of H₂O (18 g/mol); Mₛ is the molecular weight of NaCl (58.5 g/mol).

Forward osmosis performance is shown in Table 5. The AQPz protein has remarkable effects on the membrane water flux. In addition, salt rejections of the APQz-vesicle-membrane are above 50%, and the membrane selectivity of water to NaCl are as high as 33500, whereas for the controlled vesicle-membrane without AQPz incorporation, NaCl salt rejection is ˜0%. These results indicate that the increased water flux and salt rejection are resulted from the channel facilitated water transport. Theoretically, only water molecules could penetrate the biomimetic membrane through 3-step mechanism as shown in FIG. 18.

Water flux and salt flux of the AQPz-incorporated vesicular membrane is 5.58±0.97 L m⁻² h⁻¹ and 0.54±0.13 g m⁻² h⁻¹ respectively. Salt rejection was calculated to be 51%, and membrane selectivity (water to salt) was calculated to be 33500. These results prove that AQPz in the vesicular membrane serves as water channels, and that AQPz contributed to the high water selectivity of the membrane in the FO system. The AQPz-incorporated membrane shows great potential in sea water desalination.

TABLE 5
Forward osmosis performance of the membranes. Values represent the
mean ± standard deviation (error bars) with n = 3

| | | | NaCl | Selectivity |
|---|---|---|---|---|
| | Water flux | NaCl flux | Rejection | (water to |
| Membrane | [L m⁻² h ⁻¹] | [g m⁻² h⁻¹] | [%] | salt) |
| VIM^{a} | 1.19 ± 0.58 | 0.39 ± 0.21 | 0 | 9890 |
| AQPz-VIM^{b} | 5.58 ± 0.97 | 0.54 ± 0.13 | 51.3 | 33500 |

^{a}Vesicle-imprinted membrane without AQPz incorporation.
^{b}AQPz-vesicle-imprinted membrane

### Example 14

### Membrane Performance Test

In another separate comparative example, nanofiltration tests on different membranes including those prepared by the methods disclosed herein were performed in a nitrogen-pressurized dead-end stirred permeation cell. Water permeability (L) was calculated by collecting and weighing the permeate. The experiment was carried out under pressure of 5 bars. The feed solution was a MgCl₂ solution. MgCl₂ concentration in the feed and permeate was determined from electric conductance of the solutions. Salt rejection was calculated using equation (5) above. After that, second phase nanofiltration was carried out under the same conditions.

TABLE 6
Nanofiltration performance of the membranes through initiator
immobilization method. Values represent the mean ± standard
deviation (error bars) with n = 3.

| | Water | NaCl | MgCl₂ |
|---|---|---|---|
| | Permeability | Rejection | Rejection |
| Membrane | [L m⁻²h ⁻¹bar⁻¹] | [%] | [%] |
| VIM [a] | 3.4 ± 1.1 | 49 ± 3 | 54 ± 2 |
| AQPz-VIM [b] | 7.3 ± 1.6 | 60 ± 5 | 68 ± 5 |
| AQPz-VIM 2^{nd} stage [c] | 6.4 ± 2.5 | 56 ± 6 | 62 ± 7 |
| AQPz-VIM for overall 2 | 6.4 | 82.9 | 87.8 |
| stages [d] | | | |

[a] vesicular membrane without AQPz incorporation,
[b] AQPz-incorporated vesicular membrane,
[c] the second stage nanofiltration performance for AQPz-vesicle-imprinted membrane, and
[d] the overall 2 stages nanofiltration performance for AQPz-vesicle-imprinted membrane.

From Table 6, it can be seen that after 2 stages nanofiltration of the AQPz-imprinted membrane which was prepared by the methods disclosed in Example 8, the overall water permeability was 6.4 L m⁻² h⁻¹ bar⁻¹, and the overall salt rejections reached 82.9% and 87.8% for NaCl and MgCl₂ respectively. These results indicated that salt rejection of the AQPz-vesicle-imprinted membrane was greatly improved upon using initiator immobilization method disclosed herein.

### APPLICATIONS

Embodiments of the membranes disclosed herein may be capable of selectively allowing water to pass through but substantially preventing one or more undesired salts or solutes from passing through. Accordingly, embodiments of the membranes disclosed herein are suitable for use in water purification and water desalination applications and systems.

Embodiments of the membranes disclosed herein may also be capable of filtering water at high pressures of about 5 bars while maintaining structural stability and integrity. This advantageously allows the membrane to be used in nanofiltration applications where high filtration pressures of about 5 bars or more are encountered.

In some embodiments, the membranes disclosed herein are capable of being recycled and reused two or more times without substantial loss of one or more of its desired filtration qualities. Advantageously, this reduces the times the membrane has to be replaced when used in a filtration or purification system.

In certain embodiments, the water channels of the membranes are protein water channels that are inherently efficient and specialized in allowing water to pass but blocking out salts or solutes. Advantageously, by utilizing these inherently specialized water channels, the useful properties of these water channels can be tapped and water filtration can be carried out in a specialized manner without a need to massively re-design a synthetic water channel having similar properties.

In some embodiments, the water channels are harvested from bacteria cells. As such bacterial cells may be proliferated relatively easily, there can advantageously be an abundance of low cost specialized water channels.

Embodiments of the methods of making a membrane disclosed herein may also be advantageously carried out at physiological temperatures that do not disrupt the protein structure of protein water channels. Accordingly, specialized protein channels described above may be used in said methods.

Embodiments of the methods of making a membrane disclosed herein may also provide a fast, efficient and cost effective way of producing a membrane that is capable of being used for water purification and water desalination.

### SOME EMBODIMENTS (SEs)

The following recites some embodiments of the present disclosure.

SE 1: A method of making a membrane, the method comprising:

coupling a vesicle to a support substrate, the vesicle comprising a plurality of water channels thereon; and

partially embedding the vesicle coupled to the support substrate in a layer of material that is substantially impermeable to water to form the membrane.

SE 2: The method of SE 1, wherein the step of coupling the vesicle to the support substrate comprises at least one of chemical coupling and physical adsorbing the vesicle to the support substrate.
SE 3: The method of any one of SEs 1 or 2, wherein the support substrate comprises a porous substrate.
SE 4: The method of any one of the preceding SEs, wherein the layer of material that is substantially impermeable to water is hydrophobic.
SE 5: The method of any one of the preceding SEs, wherein the layer of material that is substantially impermeable to water comprises a polymer layer.
SE 6: The method of SE 5, wherein the polymer layer is selected from the group consisting of poly(ethylene glycol)dimethacrylate, polyalkylacrylate, polydiene, polyolefin, polylactone, polysiloxane, polyoxirane, polypyridine, polyvinylacetate, cellulose acetate, cellulose nitrate, polyvinylidine fluoride, polypropylene, polytetrafluoroethylene, polyethylene, polyvinylidenefluoride, polymethylpentene, polydimethylsiloxane, polybutadiene, polystyrene, polymethylmethacrylate, perfluoropolymer, polyetheretherketone, polyphenylene sulfide, liquid crystal polymers, polyimides, polyarylethersulfone, polyethersulfones, polysulfone, polymethylmethacrylate, polycarbonate, polyacrylonitrile, polyamide, and polytetrafluorethylene and copolymers thereof.
SE 7: The method of SE 5, wherein the step of partially embedding the vesicle coupled to the support substrate in the polymer layer comprises:

providing a solution of monomers on the porous substrate to partially immerse the coupled vesicle in said solution; and

polymerizing the monomers to form a layer of polymer such that the vesicle is partially embedded therein.

SE 8: The method of SE 7, wherein the step of providing a solution of monomers on the support substrate further comprises providing polymerization initiators on the support substrate.
SE 9: The method of SE 7, wherein the polymerization step is carried out at a temperature of no more than 90° C.
SE 10: The method of any one of the preceding SEs, wherein the step of coupling the vesicle to the support substrate comprises reacting a first surface functional group of the vesicle with a second surface functional group of the support substrate to form a covalent bond.
SE 11: The method of in SE 10, wherein the step of coupling the vesicle to the support substrate further comprises physically adsorbing the vesicle to the support substrate.
SE 12: The method of any one of the preceding SEs, further comprising functionalizing the vesicle with a first surface functional group and functionalizing the support substrate with a second surface functional group prior to the coupling step.
SE 13: The method of SEs 11 or 12, wherein the first functional group and/or the second functional group is independently selected from the group consisting of alkenyl, alkynyl, Benzyl bromide, halo, fluoro, chloro, bromo, iodo, hydroxyl, carbonyl, aldehyde, haloformyl, carbonate ester, carboxylate, carboxyl, ester, methoxy, hydroperoxy, peroxy, ether, hemiacetal, hemiketal, primary/secondary/tertiary amine, 4° ammonium ion, primary/secondary ketimine, primary/secondary aldimine, imide, azide, azo, cyanate, isocyanate, nitrate, nitrile, isonitrile, nitrosooxy, nitro, nitroso, pyridyl, sulphydryl, sulfide, disulfide, sulfinyl, sulfonyl, sulfino, sulfo, thiocyanate, isothiocyanate, carbonothioyl, carbonothioyl, phosphono, borono, borino, acyl chloride, phosphorodiester, thiophosphorodiester, aminooxy, carbonate, carbamate, hydrazone, oxime halogen, epoxide, hydrazide, maleimide, succinimidyl glutarate, succimidyl succinate, succinic acid and tresylate functional groups.
SE 14: The method of any one of the preceding SEs, wherein the water channels are selectively permeable to allow water to pass through but substantially prevent one or more types of solutes from passing through.
SE 15: The method of SE 14, wherein the solutes comprise one or more ions selected from the group consisting of sodium, calcium, magnesium, potassium, borate, chloride, sulfate, bicarbonate, bromide, strontium, fluoride, and mixtures thereof.
SE 16: The method of any one of the preceding SEs, wherein the water channels comprise protein water channels.
SE 17: The method of SE 16, wherein the protein water channels comprise aquaporin water channels.
SE 18: The method of SE 16 or 17, wherein the protein water channels are harvested from bacteria cells.
SE 19: The method of any one of the preceding SEs, wherein the vesicle comprises an amphiphilic membrane.
SE 20: The method of SE 19, further comprising forming the vesicle having the amphiphilic membrane with a material that has a phase transition temperature no more than 60° C. prior to the step of coupling the vesicle to the support substrate.
SE 21: The method of SEs 19 or 20, wherein the material that has a phase transition temperature no more than 60° C. comprises unsaturated hydrocarbon groups.
SE 22: The method of any one of SEs 19 to 21, wherein the amphiphilic membrane comprises a polymer, a lipid or mixtures thereof.
SE 23: The method of SE 21, wherein the polymer comprises a block copolymer.
SE 24: The method of any one of SEs 20 to 23, further comprising incorporating the water channels into the amphiphilic membrane prior to the coupling step.
SE 25: The method of any one of the preceding SEs, wherein the support substrate is hydrophilic.
SE 26: The method of any one of the preceding SEs, wherein the layer of material that is substantially impermeable to water has a thickness that is less than the diameter of the vesicle.
SE 27: A method of making a membrane, the method comprising:

forming a vesicle having an amphiphilic membrane with a lipid, a polymer or mixtures thereof that has a phase transition temperature no more than 60° C.;

incorporating protein water channels into the amphiphilic membrane;

coupling the vesicle onto a porous substrate membrane by chemically coupling the vesicle to the substrate and/or physically adsorbing the vesicle to the porous substrate;

providing a solution of monomers on the porous substrate to partially immerse the coupled vesicle in said solution; and

polymerizing the monomers to form a layer of polymer such that the vesicle is partially embedded therein, wherein the layer of polymer is substantially impermeable to water.
SE 28: A membrane for water filtration, the membrane comprising:
a support substrate;
a plurality of vesicles coupled to the support substrate, each vesicle comprising a plurality of water channels thereon; and
a layer of material disposed over the support substrate that partially encapsulates the plurality of vesicles, wherein said layer of material is substantially impermeable to water.
   SE 29: The membrane of SE 28, wherein the support substrate comprises a porous substrate.
   SE 30: The membrane of SE 28, wherein the layer of material that is substantially impermeable to water is hydrophobic.
   SE 31: The membrane of any one of the SEs 28 to 30, wherein the layer of material that is substantially impermeable to water comprises a polymer layer.
   SE 32: The membrane of SE 31, wherein the polymer layer is selected from the group consisting of poly(ethylene glycol)dimethacrylate, polyalkylacrylate, polydiene, polyolefin, polylactone, polysiloxane, polyoxirane, polypyridine, polyvinylacetate, cellulose acetate, cellulose nitrate, polyvinylidine fluoride, polypropylene, polytetrafluoroethylene, polyethylene, polyvinylidenefluoride, polymethylpentene, polydimethylsiloxane, polybutadiene, polystyrene, polymethylmethacrylate, perfluoropolymer, polyetheretherketone, polyphenylene sulfide, liquid crystal polymers, polyimides, polyarylethersulfone, polyethersulfones, polysulfone, polymethylmethacrylate, polycarbonate, polyacrylonitrile, polyamide, and polytetrafluorethylene and copolymers thereof.
   SE 33: The membrane of any one of SEs 28 to 32, wherein the vesicles are chemically coupled to the support substrate via a first surface functional group on the vesicles and a second surface functional group on the support substrate.
   SE 34: The membrane of any one of SEs 28 to 33, wherein the vesicles are coupled to the porous substrate via covalent bonding and/or physical interactions.
   SE 35: The membrane of SE 33, wherein the first functional group and/or the second functional group is independently selected from the group consisting of alkenyl, alkynyl, Benzyl bromide, halo, fluoro, chloro, bromo, iodo, hydroxyl, carbonyl, aldehyde, haloformyl, carbonate ester, carboxylate, carboxyl, ester, methoxy, hydroperoxy, peroxy, ether, hemiacetal, hemiketal, primary/secondary/tertiary amine, 4° ammonium ion, primary/secondary ketimine, primary/secondary aldimine, imide, azide, azo, cyanate, isocyanate, nitrate, nitrile, isonitrile, nitrosooxy, nitro, nitroso, pyridyl, sulphydryl, sulfide, disulfide, sulfinyl, sulfonyl, sulfino, sulfo, thiocyanate, isothiocyanate, carbonothioyl, carbonothioyl, phosphono, borono, borino, acyl chloride, phosphorodiester, thiophosphorodiester, aminooxy, carbonate, carbamate, hydrazone, oxime halogen, epoxide, hydrazide, maleimide, succinimidyl glutarate, succimidyl succinate, succinic acid and tresylate functional groups.
   SE 36: The membrane of any one of SEs 28 to 35, wherein the water channels are selectively permeable to allow water to pass through but substantially prevent one or more types of solutes from passing through.
   SE 37: The membrane of SE 36, wherein the solutes comprises one or more ions selected from the group consisting of sodium, calcium, magnesium, potassium, borate, chloride, sulfate, bicarbonate, bromide, strontium, fluoride, and mixtures thereof.
   SE 38: The membrane of any one of SEs 28 to 37, wherein the water channels comprise protein water channels.
   SE 39: The membrane of SE 38, wherein the protein water channels comprise aquaporin water channels.
   SE 40: The membrane of SE 38 or 39, wherein the protein water channels are harvested from bacteria cells.
   SE 41: The membrane of any one of SEs 28 to 40, wherein each of the vesicles comprises an amphiphilic membrane.
   SE 42: The membrane of SE 41, wherein the amphiphilic membrane is formed of a material that has a phase transition temperature of no more than 60° C.
   SE 43: The membrane of SE 42, wherein the material that has a phase transition temperature of no more than 60° C. comprises unsaturated hydrocarbon groups.
   SE 44: The membrane of any one of SEs 41 to 43, wherein the amphiphilic membrane comprises a polymer, a lipid or mixtures thereof.
   SE 45: The membrane of SE 44, wherein the polymer comprises a block copolymer.
   SE 46: The membrane of any one of SEs 28 to 45, wherein the support substrate is hydrophilic.
   SE 47: The membrane of any one of SEs 28 to 46, wherein the layer of material that is substantially impermeable to water has a thickness that is less than the average diameter of the vesicles.
   SE 48: The membrane of SE 47, wherein the layer of material that is substantially impermeable to water has a thickness of from 10 nanometers to 5 micrometers.
   SE 49: The membrane of SE 29, wherein the porous substrate has a pore density of from 5% to 90%
   SE 50: The membrane of SE 29, wherein the porous substrate has an average pore size of between 5 nm to 200 nm.
   SE 51: The membrane of any one of SEs 28 to 50, wherein the vesicles have an average diameter of from 30 nanometers to 5 micrometers.
   SE 52: The membrane of any one of SEs 28 to 51, wherein the membrane has a sodium chloride rejection percentage from 20% to 99.9% when said membrane is used to separate sodium chloride from a feed solution comprising the sodium chloride, and wherein the sodium chloride rejection percentage is calculated by the formula,

$$Sodium\_Chloride \_rejection = ( 1 - \frac{( {C}_{f 0} {V}_{f 0} - {C}_{f 1} {V}_{f 1} ) / ( Δ {W}_{d} / {D}_{w} )}{{C}_{f 0}} ) \times 100 \%$$

where C_{f0} is a initial sodium chloride concentration of the feed solution (g/L); V_{f0} is a initial volume of the feed solution (L); C_{f1} is a final sodium chloride concentration of the feed solution (g/L); V_{f1} is a final volume of the feed solution (L); ΔW_{d} is either the weight increase of a permeate solution in a hydraulic pressure driven filtration or the weight increase of a draw solution in a forward osmosis process (g); D_{w} is the density of water which is 1000 g/L.
SE 53: The membrane of SE 52, wherein membrane is capable of maintaining the sodium chloride rejection percentage in the range of from 20% to 99.9% when the filtration pressure is from 1 bar to 30 bars.
SE 54: The membrane of SE 52, wherein membrane is capable of maintaining the solute rejection percentage in the range of from 20% to 99.9% after more than two filtration cycles.
SE 55: Use of the membrane of any one of SEs 28 to 54 in a water filtration system.

It will be appreciated by a person skilled in the art that other variations and/or modifications may be made to the embodiments disclosed herein without departing from the spirit or scope of the disclosure as broadly described. The present embodiments are, therefore, to be considered in all respects to be illustrative and not restrictive.

1. A method of making a membrane, the method comprising:
coupling a vesicle to a support substrate, the vesicle comprising a plurality of water channels thereon; and
partially embedding the vesicle coupled to the support substrate in a layer of material that is substantially impermeable to water to form the membrane.

2. The method of claim 1, wherein the step of coupling the vesicle to the support substrate comprises at least one of chemical coupling and physical adsorbing the vesicle to the support substrate.

3. The method of claim 1, wherein the support substrate comprises a porous substrate.

4. The method of claim 1, wherein the layer of material that is substantially impermeable to water is hydrophobic.

5. The method of claim 1, wherein the layer of material that is substantially impermeable to water comprises a polymer layer and the step of partially embedding the vesicle coupled to the support substrate in the polymer layer comprises:
providing a solution of monomers on the porous substrate to partially immerse the coupled vesicle in said solution; and
polymerizing the monomers to form a layer of polymer such that the vesicle is partially embedded therein.

6. The method of claim 1, wherein the step of coupling the vesicle to the support substrate comprises reacting a first surface functional group of the vesicle with a second surface functional group of the support substrate to form a covalent bond.

7. The method of claim 1, wherein the water channels comprise aquaporin water channels.

8. The method of claim 1, further comprising forming the vesicle having an amphiphilic membrane with a material that has a phase transition temperature no more than 60° C. prior to the step of coupling the vesicle to the support substrate.

9. The method of claim 8, wherein the material that has a phase transition temperature no more than 60° C. comprises unsaturated hydrocarbon groups.

10. A method of making a membrane, the method comprising:
forming a vesicle having an amphiphilic membrane with a lipid, a polymer or mixtures thereof that has a phase transition temperature no more than 60° C.;
incorporating protein water channels into the amphiphilic membrane;
coupling the vesicle onto a porous substrate membrane by chemically coupling the vesicle to the substrate and/or physically adsorbing the vesicle to the porous substrate;
providing a solution of monomers on the porous substrate to partially immerse the coupled vesicle in said solution; and
polymerizing the monomers to form a layer of polymer such that the vesicle is partially embedded therein, wherein the layer of polymer is substantially impermeable to water.

11. A membrane for water filtration, the membrane comprising:
a support substrate;
a plurality of vesicles coupled to the support substrate, each vesicle comprising a plurality of water channels thereon; and
a layer of material disposed over the support substrate that partially encapsulates the plurality of vesicles, wherein said layer of material is substantially impermeable to water.

12. The membrane of claim 11, wherein the support substrate comprises a porous substrate.

13. The membrane of claim 11, wherein the layer of material that is substantially impermeable to water is hydrophobic.

14. The membrane of claim 11, wherein the layer of material that is substantially impermeable to water comprises a polymer layer.

15. The membrane of claim 14, wherein the polymer layer is selected from the group consisting of poly(ethylene glycol)dimethacrylate, polyalkylacrylate, polydiene, polyolefin, polylactone, polysiloxane, polyoxirane, polypyridine, polyvinylacetate, cellulose acetate, cellulose nitrate, polyvinylidine fluoride, polypropylene, polytetrafluoroethylene, polyethylene, polyvinylidenefluoride, polymethylpentene, polydimethylsiloxane, polybutadiene, polystyrene, polymethylmethacrylate, perfluoropolymer, polyetheretherketone, polyphenylene sulfide, liquid crystal polymers, polyimides, polyarylethersulfone, polyethersulfones, polysulfone, polymethylmethacrylate, polycarbonate, polyacrylonitrile, polyamide, and polytetrafluorethylene and copolymers thereof.

16. The membrane of claim 11, wherein the water channels are selectively permeable to allow water to pass through but substantially prevent one or more types of solutes from passing through, wherein the solutes comprises one or more ions selected from the group consisting of sodium, calcium, magnesium, potassium, borate, chloride, sulfate, bicarbonate, bromide, strontium, fluoride, and mixtures thereof.

17. The membrane of claim 11, wherein the water channels comprise aquaporin water channels.

18. The membrane of claim 11, wherein each of the vesicles comprises an amphiphilic membrane selected from the group consisting of a polymer, a lipid or mixtures thereof.

19. The membrane of claim 11, wherein the layer of material that is substantially impermeable to water has a thickness that is less than the average diameter of the vesicles.

20. The membrane of claim 11, wherein the layer of material that is substantially impermeable to water has a porosity of no more than about 30%.

21. The membrane of claim 11, wherein the vesicles have an average diameter of from 30 nanometers to 5 micrometers.

22. The membrane of claim 11, wherein the membrane has a sodium chloride rejection percentage from 20% to 99.9% when said membrane is used to separate sodium chloride from a feed solution comprising the sodium chloride, and wherein the sodium chloride rejection percentage is calculated by the formula,
$$Sodium\_Chloride \_rejection = ( 1 - \frac{( {C}_{f 0} {V}_{f 0} - {C}_{f 1} {V}_{f 1} ) / ( Δ {W}_{d} / {D}_{w} )}{{C}_{f 0}} ) \times 100 \%$$
where C_{f0} is a initial sodium chloride concentration of the feed solution (g/L); V_{f0} is a initial volume of the feed solution (L); C_{f1} is a final sodium chloride concentration of the feed solution (g/L); V_{f1} is a final volume of the feed solution (L); ΔW_{d} is either the weight increase of a permeate solution in a hydraulic pressure driven filtration or a draw solution in a forward osmosis process (g); D_{w} is the density of water which is 1000 g/L.

23. The membrane of claim 22, wherein the membrane is capable of maintaining the sodium chloride rejection percentage in the range of from 20% to 99.9% when the filtration pressure is from 1 bar to 30 bars.

24. The membrane of claim 22, wherein the membrane is capable of maintaining the solute rejection percentage in the range of from 20% to 99.9% after more than two filtration cycles.

25. A water filtration system comprising the membrane of claim 11.
